(19) United States
(12) Patent Application Publication
(10) Pub. No.: US 2024/0162669 A1
(43) Pub. Date: May 16, 2024

(54) An AC power appliance inlet

(71) Applicant: EGGTRONIC ENGINEERING SPA, MODENA (IT)

(72) Inventors: Igor SPINELLA, MODENA (IT); Camilla BETTINELLI, MODENA (IT); Simone BONETTI, MODENA (IT); Serena SACCHETTO, MODENA (IT); Alice ROVERSI, MODENA (IT)

(21) Appl. No.: 18/551,896

(22) PCT Filed: Mar. 23, 2023
(86) PCT No.: PCT/EP2022/057635

§ 371 Date: Sep. 22, 2023

(30) Foreign Application Priority Data
Mar. 23, 2021 (GB) 2104009.2

(51) Int. Cl. H01R 24/76; H01R 12/70

(52) U.S. Cl. CPC H01R 24/76; H01R 12/7088

(57) ABSTRACT

Appliance AC power inlet comprising a housing (3) including a recessed cavity; and at least two electrical pins (4) that are arranged inside the recessed cavity. The height of the recessed cavity is less than approximately 7 mm.

### BACKGROUND OF THE INVENTION

### 1. Field of the Invention

The field of the invention relates to a mains power interconnection coupler. The term ‘interconnection coupler’ is used, especially in the relevant technical standards (see IEC60320), to refer to the electrical connector (colloquially often called a ‘plug’) and the appliance inlet (colloquially often called a socket or port) that the connector is inserted into. So an interconnection coupler is, for example, the physical interface made up of an inlet (or socket or port) in the appliance, and a connector (or plug) that is inserted into the inlet (or socket or port) to connect the primary circuit of the appliance to a power cable that is itself connected to the mains AC power. IEC60320 defines interconnection couplers that work at voltages not exceeding 250 V (A.C.) and rated currents not exceeding 16 A, this range encompasses many types of equipment (e.g. laptops, desktop computers, televisions, telephones, lights, etc.) and is one of the important application areas for this invention.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

Interconnection couplers are used to transfer mains AC power and low voltage (e.g. under 250V) from an AC wall socket to the primary circuit of an electrical appliance. Electrical appliances fitted with a permanently attached electrical connector cannot be used across different countries because of incompatible AC wall sockets

Detachable interconnection couplers are one way of countering this problem and are used in many types of equipment requiring worldwide distribution, such as office equipment, measuring instruments, IT environments or medical devices. In a detachable interconnection coupler, the appliance uses power cable that at one end terminates in a standard connector (e.g. a C1 connector, as defined in IEC60320) that can be inserted into the corresponding inlet (e.g. a C2 inlet) in the appliance itself. The other end of the power cable can be permanently wired to a connector or plug appropriate for a specific country: e.g. for the US market, a NEMA-1 plug can be fitted to the power cable; for Europe, a CEE 7 plug can be fitted. The advantage of this sort of plug and play power cable, using a detachable interconnection coupler, instead of a permanent wiring to the appliance, is that only a cable needs to be changed to suit each national market, with its own electrical conventions. Hence manufacturers can make and sell the same product across different countries by including a country-specific supply cord set in the product packaging with the cord set including a connector and a country-specific plug. In turn, model variations are minimized, and factory testing is simplified.

IEC 60320 defines a comprehensive range of connectors and their corresponding appliance inlets. IEC 60320 represents the most used means of connecting a detachable cord set to electrical equipment and is used worldwide. IEC 60320 defines the mechanical, electrical, and thermal requirements and safety goals of 13 power couplers, as listed in the table shown in FIG. 1. The shape and dimensions of appliance connectors and matching appliance inlets are coordinated so that a connector with lower current rating, temperature rating, or polarization cannot be inserted into an appliance inlet that requires higher ratings. The IEC 60320 specification also defines regulations to provide safe products to end-users. As an example, to achieve electric shock protection, creepage distances and clearance through insulation materials are regulated, as shown in the table of FIG. 2. Hence when products are manufactured according to the IEC 60320 specification, users and appliances are properly protected and the safety risks are eliminated.

It is useful to summarise the terminology used in the IEC 60320 standard: there are appliance inlets and outlets, plug connectors, cord sets, interconnection cord sets, which are each defined as follows:
Appliance inlet: “part of the interconnection coupler integrated as a part of an appliance or incorporated as a separate part in the appliance or equipment or intended to be fixed to it”.
Appliance outlet: “part of the interconnection coupler which is the part integrated or incorporated in the appliance or equipment or intended to be fixed to it and from which the supply is obtained”.
Plug connector: “part of the interconnection coupler integral with or intended to be attached to one cord”.
Cord set: “assembly consisting of one cable or cord fitted with one non-rewirable plug and one non-rewirable connector, intended for the connection of an electrical appliance or equipment to the electrical supply”.
Interconnection cord set: “assembly consisting of one cable or cord fitted with one non-rewirable plug connector and one non-rewirable connector, intended for the interconnection between two electrical appliances”.

In IEC 60320, the different power couplers are categorised and labelled with the letter C followed by a number, with the outlets having an odd number (e.g. C21) and the mating inlet having an even number (e.g. C22), as shown in FIG. 1. Inlets that include two pin contacts, a live pin and a neutral pin, are referred as “ungrounded”. For safety reasons, a third terminal for ground connection or earth pin may be added in some cases.

Inlets that include three pins are referred as “grounded” Although the latest version of IEC 60320 dates to 2018, the legacy geometrical IEC standards represent a deterrent to the evolution of appliance inlets, which, in turn, may curb emerging design trends for consumer electronics. Additionally, the shape of the power couplers is unaltered from the 1970s when the standard was first published. As a result, the existing IEC 60320 specification is not up to date with rapid lifestyle evolutions, the growing demand for device portability, and the need to always be “electrically fed”.

The IEC 60320 specification, and especially the dimensions and shape of the power couplers, thus represent a bottleneck for size shrinkage of electrical or electronic products that require AC power (e.g. laptop power supplies, PC power supplies, domestic audio, video equipment, gaming devices, peripherals, servers, rack-mounted devices, etc.). The existing IEC 60320 standard therefore sets a universally accepted blueprint for the design of power couplers; but that universality restricts product designers in the creation of new designs with more compact equipment, or equipment that uses internal space as efficiently as possible, since doing so would be incompatible with the interconnection couplers defined by the IEC 60320 standard.

So, despite the intense pressures on designers of devices that need AC power (e.g. laptop power supplies, PC power supplies, domestic audio, video equipment, gaming devices, peripherals, servers, rack mounted devices etc.) to design compact equipment, or equipment that uses internal space as efficiently as possible, the overwhelming bias or technical prejudice in this field is to work with the existing, extensive and universally accepted range of appliance couplers that conform to IEC 60320, such as the C1-C24 range of appliance couplers shown in FIG. 1.

### SUMMARY OF THE INVENTION

The invention is a mains AC power inlet with a housing including a recessed cavity and at least two electrical pins that are arranged inside the recessed cavity; and in which the height of the recessed cavity is less than approximately 7 mm.

Another aspect of the invention is a mains AC interconnection coupler comprising a mains power inlet with a housing including a recessed cavity and at least two electrical pins that are arranged inside the recessed cavity; and in which the height of the recessed cavity is less than approximately 7 mm. The interconnection coupler also comprises a connector for connecting into the mains power inlet.

Another aspect of the invention is a connector for connecting into a mains power inlet, the mains power inlet comprising at least two pins. The connector comprises: a housing including at least two recessed openings or holes for receiving each pin of the mains power inlet, in which the recessed holes include electrical contacts, and in which the height of the housing is less than approximately 7 mm.

Another aspect of the invention is an electronic device integrated with a mains power inlet for an electrical connector. The mains power inlet comprises a housing including a recessed cavity and at least two electrical pins that are arranged inside the recessed cavity; and in which the height of the recessed cavity is less than approximately 7 mm.

The mains AC interconnection coupler leads to many advantages.

The inlet is significantly smaller in height than even the smallest current IEC 60320 inlets (e.g. C1 inlets), while still achieving the necessary IEC regulation requirements. The matching connector or plug can therefore be designed to be significantly smaller than standard IEC 60320 connector plugs. The inlet may have a front surface with a generally rectangular opening.

The inlet may be significantly smaller in width than current IEC 60320 inlets. The pin shape and clearance distance between the pins may be specifically chosen to reduce the height of the housing.

The housing may have a box-shaped structure. An advantage of the box-shaped structure is that the housing can be easily mounted in or on an electronic device. With a box-shaped housing, contact points can be easily attached to the housing and designed according to either a horizontal or vertical orientation; they may be combined with THT (through-hole technology) or SMD (surface mount device) configurations.

The invention enables electronic products using the ‘micro’ inlets defined above, as well as cord sets using the matching ‘micro’ connectors defined above, to also be significantly reduced in size.

A consolidated list of key features is in the Appendix.

### BRIEF DESCRIPTION OF THE FIGURES

Aspects of the invention will now be described, by way of example(s), with reference to the following Figures, which each show features of the invention implemented in a device called a ‘micro-connector’ and a ‘micro-inlet’ (which together form a ‘micro-coupler’):

FIG. 1 shows a table with the dimension and tolerances for the different IEC interconnection couplers.

FIG. 2 shows a table providing the minimum creepage distances and clearances stated by IEC 60320 for mains AC connectors.

FIG. 3A shows a table comparing the geometrical and electrical parameters between the micro-couplers and the one regulated by the IEC 60320 standard.

FIG. 3B shows a table with the dimension and tolerances for the micro-connectors and micro-inlets.

FIGS. 4A-4E shows the front view of USB-A port 4A, an example of a micro-inlet 4B, another example of a micro-inlet 4C, an IEC C8 inlet 4D and an IEC C6 inlet.

FIGS. 5A-5C shows the front view, side view and back axonometric view of an E4 ungrounded power inlet.

FIGS. 6A-6C shows a front view 6A of the E4 ungrounded micro-inlet, with cross section notation as well as its longitudinal (AA) cross section 6B and transverse (BB) cross section 6C.

FIGS. 7A-7C shows various examples of the case frame of the micro-inlet, and their mechanical integration within the device; from left to right, bank 7A, panel 7B and snap mounting 7C.

FIGS. 8A-8C shows various examples of the contact points of the AC power micro-inlet, and their electric integration with the device; from left to right, horizontal THT 8A, vertical TH T 8B and SMD 8C.

FIGS. 9A-9C shows the front view 9A, bottom view 9B and perspective view 9C of an example of an SMD configuration for the micro-inlet including a soldering pad.

FIGS. 10A-10C shows the front view 10A, bottom view 10B and perspective view 10C of an example of an SMD configuration for the micro-inlet, including two soldering pads.

FIGS. 11A-11B shows the front view 11A and perspective view 11B of an E3 ungrounded plug micro-inlet, implemented according to the vertical pin design.

FIGS. 12A-12B shows the front view 12A and the longitudinal (AA) cross section 12B of the E3 ungrounded micro-connector.

FIGS. 13A-13D shows a front view of an E3 micro-connector inserted into the E4 micro-inlet 13A, a longitudinal (AA) section of E3 micro-connector to be inserted into the E4 micro-inlet 13B, a conductive pin 4 and contact points 6 of the E4 micro-inlet 13C and an electrical contact 2 of the plug 13D.

FIGS. 14A-14D shows several variations of the electrical contact, including symmetrical point-like bending 14A, single point-like bending 14B, planar bending 14C, and terminal bending 14D.

FIGS. 15A-15D shows several views of an example of electrical contact of the connector.

FIGS. 16A-16D shows several views of the matching E3/E4 micro-coupler including the electrical contact of FIG. 15.

FIGS. 17A-17C shows an example of a female-male cable or extension cord integrated with the micro-coupler.

FIGS. 18A-18C shows a front view 18A, side axonometric view 18B and back axonometric view 18C of the E2 grounded power inlet.

FIGS. 19A-19C shows a front view of the E2 grounded power inlet 19A, with section notation; longitudinal (AA) section 19B and transverse (BB) section 19C of the E4 micro-inlet.

FIGS. 20A-20B shows an axonometric view 20A and front view 20B of the E1 grounded plug.

FIGS. 21A-21B shows a front view 21A and the longitudinal (AA) section 21B and of the E1 grounded micro-connector.

FIGS. 22A-22B shows a front view of an E1 micro-connector inserted into the E2 power inlet and a longitudinal (AA) section of E1 micro-connector to be inserted into the E2 micro-inlet.

FIGS. 23A-23D shows the length of the earth pin of the micro-inlet 23A compared to the length of the live or neutral pin of the micro-inlet 23B and contact points 23C, 23D of the E2 micro-inlet.

FIGS. 24A-24C shows a front view 24A, side axonometric view 24B and back axonometric view 24C of the E4 ungrounded micro-inlet, implemented according to the reinforced vertical pin design.

FIGS. 25A-25E shows a front view of the E4 ungrounded micro-inlet with reinforced pin 25A, with section notation and the corresponding longitudinal (AA) section 25B and transverse (BB) section 25C, and the main geometrical parameters involved in the optimization of reinforced vertical pin design 25D and 25E.

FIGS. 26A-26B shows a perspective view 26A and front view 26B the matching E3 ungrounded micro-connector, implemented according to the reinforced vertical pin design.

FIGS. 27A-27B shows a front view of the E3 ungrounded micro-connector with section notation 27A and the corresponding longitudinal (AA) section 27B.

FIGS. 28A-28D shows a front view of an E3 plug inserted into the E4 micro-inlet included a reinforced pin design 28A, a longitudinal (AA) section of E3 micro-connector to be inserted into the E4 power inlet 28B, a conductive pin 4 and contact points 6 of the E4 micro-inlet 28C and an electrical contact 2 of the plug 28D.

FIGS. 29A-29C shows a front view 29A, a side perspective view 29B and a back perspective view 29C of a E2 grounded micro-inlet with a reinforced vertical pin design.

FIGS. 30A-30C shows a front view of the E2 grounded micro-inlet 30A, with section notation and the corresponding longitudinal (AA) section 30B and transverse (BB) section 30C of the E2 micro-inlet, implemented according to the reinforced vertical pin design.

FIGS. 31A-31B shows a perspective view 31A and front view 31B of the matching E1 grounded micro-connector.

FIGS. 32A-32B shows a front view of the E1 grounded plug 32A, with section notation and the corresponding longitudinal (AA) section 32B.

FIGS. 33A-33B shows a front view of an E1 micro-connector inserted into the E2 micro-inlet including a reinforced pin design 33A, a longitudinal (AA) section of E1 micro-connector to be inserted into the E2 micro-inlet 33B.

FIGS. 34A-34C shows a front view 34A, side perspective view 34B and back perspective view of the E4 ungrounded micro-inlet, implemented according to the horizontal pin design.

FIGS. 35A-35C shows a front view of the E4 ungrounded micro-inlet 35A, with section notation and the corresponding longitudinal (AA) section 35B and transverse (BB) section 35C with the E4 ungrounded micro-inlet configured with a horizontal pin design.

FIGS. 36A-36B show a front view 36A and a perspective view 36B of the matching E3 micro-connector, implemented according to the horizontal pin design.

FIGS. 37A-37B show a front view 37A of the matching E3 ungrounded plug with the horizontal pin design, with section notation and the corresponding longitudinal (AA) section 37B.

FIGS. 38A-38D shows a front view of the E3 micro-connector inserted into the E4 micro-inlet 38A, a longitudinal (AA) section of an E3 micro-connector and an E4 micro-inlet facing each other 38B, a electrical contact 38C of the E3 micro-connector and a conductive pin 38D of the E4 micro-inlet.

FIGS. 39A-39C show a front view 39A, side perspective view 39B and back perspective view 39C of the E2 grounded micro-inlet, implemented according to the horizontal pin design.

FIGS. 40A-40C shows a front view of the E2 grounded micro-inlet 40A, with section notation and the corresponding longitudinal (AA) section 40B and transverse (BB) section 40C of the E2 micro-inlet, implemented according to the horizontal pin design.

FIGS. 41A-41B shows a perspective view 41A and front view 41B of the matching E1 grounded micro-connector, implemented according to the horizontal pin design.

FIGS. 42A-42B shows a front view of the E1 grounded micro-connector 42A, with section notation, and the corresponding longitudinal (AA) section 42B of the E1 grounded micro-connector, implemented according to the horizontal pin design

FIGS. 43A-43B shows a front view of the E1 micro-connector inserted into the E2 micro-inlet, according to the horizontal pin design and a longitudinal (AA) section of the E1 micro-connector and E2 micro-inlet separated and facing each other.

FIGS. 44A-44C shows a side view 44A of an E2 earth pin and the matching E1 electrical contact, and the top views of a live or neutral pin 44B and of the earth pin 44C with matching electrical contact.

FIGS. 45A-45B shows an example of a desktop power supply integrated with a micro-inlet 45A and with a standard IEC C8 inlet 45B.

FIGS. 46A-46B shows side views of the desktop power supply integrated with an integrated micro-inlet 46A and with a standard IEC C8 inlet 46B.

FIGS. 47A-47B shows perspective views of the desktop power supply integrated with a micro-inlet 47A and with a standard IEC C8 inlet 47B.

FIGS. 48A-48B show side views of a micro-inlet integrated with a wireless charger with AC input 48A and compared to the one equipped with standard IEC C8 inlet 48B.

FIGS. 49A-49B show perspective views of a micro-inlet integrated with a wireless charger with AC input 49A and compared to the one equipped with standard IEC C8 inlet 49B.

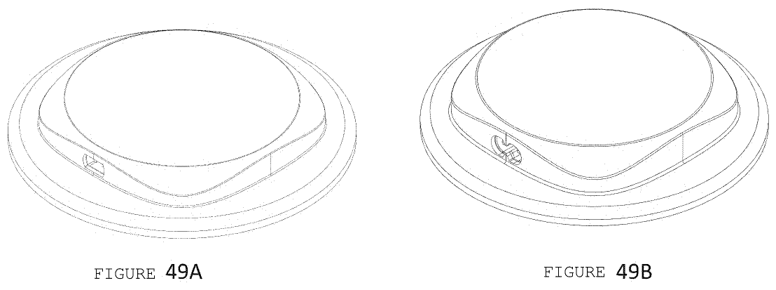

FIGS. 50A-50C shows examples of cables in which one end of the cable includes a micro-connector that is configured to be inserted into a micro-inlet.

FIGS. 51A-51C shows a sectional side view 51A, bottom perspective view 51B and bottom view 51C of a cable with a micro-connector that is inserted into a device, such as a wireless charger.

### DETAILED DESCRIPTION

As noted earlier, the interconnection couplers that implement this invention are connectors that may be referred to as ‘micro-connectors’ and inlets that may be referred to as ‘micro-inlets’. Together, they form ‘micro-couplers’.

Several micro-connectors and micro-inlets of significant reduced size are now described in detail.

The micro-connectors and micro-inlets are thinner than standards-defined IEC connectors and inlets and, at the same time, are compliant with the IEC 60320 regulations for electrical, safety and thermal requirements. An advantage of the micro-inlets when integrated to electrical or electronic devices is a reduction in size of the devices themselves; micro-connectors also lead to a reduction in size of the cord set used to connect to a mains power outlet.

The micro-connectors and micro-inlets are also configured to be unique and easily recognizable from other existing power inlets and connectors, such as other AC power inlets. They are also developed using the sleekest silhouettes, using just elementary shapes (e.g. the simple rectangular housing of the micro-inlet) to promote a new minimalistic design, combining both technology and aesthetics. The micro-couplers become seamless and nearly invisible, perfectly fused with the device.

Design Criteria

The integration of power inlets within thinner and thinner devices represents a driving criterion for the micro-couplers. The size reduction is thus consistent with the general shrinkage of dimension undergone by a wide number of various electronic products.

The micro-couplers may be reduced in at least one of the following dimensions: height, width and/or depth, compared to existing interconnection couplers.

In particular, the micro-couplers have a housing with a height or thickness that is below or equal to approximately 10 mm. As a comparison, the current IEC couplers such as C5/C6 for grounded appliances, and C7/C8 for ungrounded appliances have a housing with a height set, respectively, at 17.5 mm and 15 mm.

Advantageously, the micro-inlets have a recessed cavity that is below or equal to approximately 7 mm. Hence the height of the recessed cavity is also substantially smaller than the height of current IEC inlets, which is set at 13.2 mm and 8.5 mm for C6 and C8 inlets respectively.

In addition, the maximum working power of the proposed coupler is raised up to 750 W, as compared to the 625 W of the IEC couplers: while the maximum rms voltage is kept at 250 V as the IEC couplers, the maximum rms current is increased, from the 2.5 A level for C5/C6 and C7/C8, to 3 A for the micro-couplers.

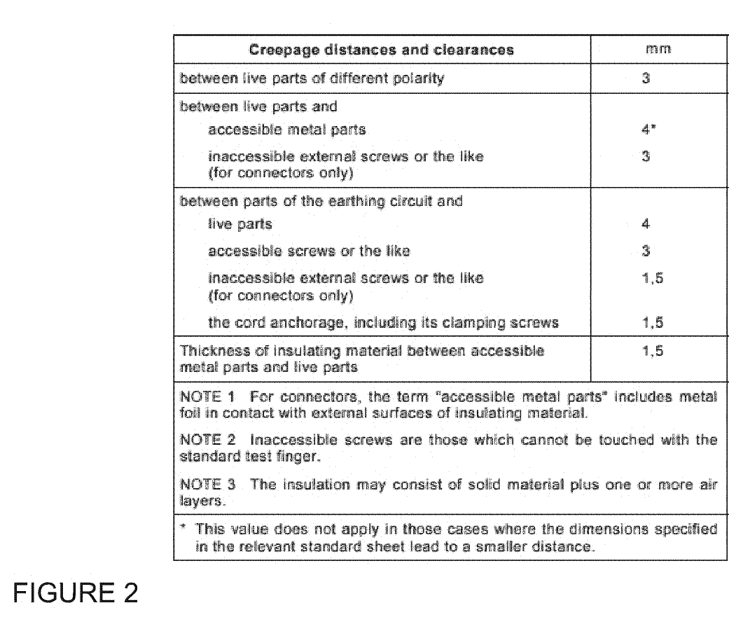

Additionally, the micro-couplers are configured to meet the same safety requirements as regulated by IEC 60320. The design of the micro-couplers achieves the minimum dimension required by the IEC 60320 standards for clearance and creepage distances (see FIG. 2) to avoid shock and short circuit. This ensures that users and appliances are properly protected when integrated with the micro-couplers, micro-inlets, or micro-connectors.

The following micro-coupler codes are also used in the following sections:
E1: grounded connector or micro-connector.
E2: grounded inlet or micro-inlet matching the E1 connector.
E3: ungrounded connector or micro-connector.
E4: ungrounded inlet or micro-inlet matching the E3 connector.

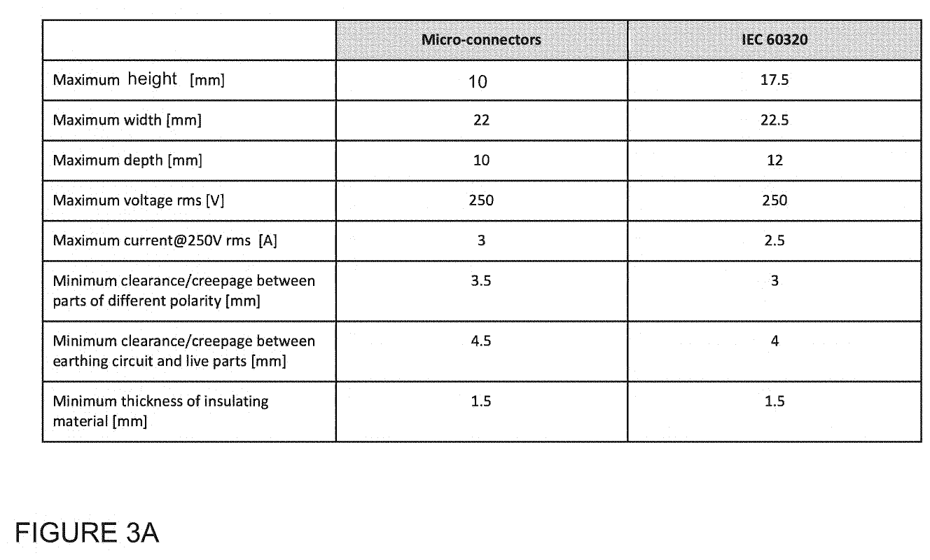

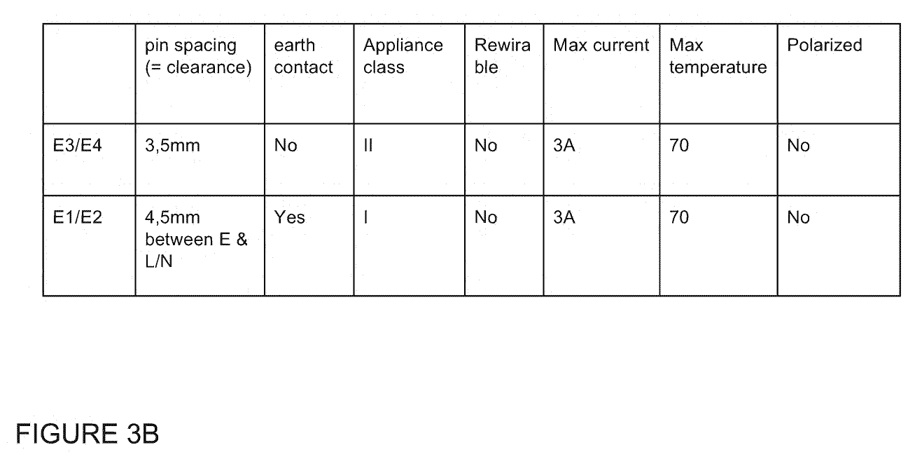

FIG. 3A provides a table listing the geometrical and electrical parameters of the micro-couplers described in the following sections and compared to the geometrical and electrical parameters of the couplers regulated by the IEC 60320 specification.

FIG. 3B provides a table with the dimensions and tolerances for the micro-couplers.

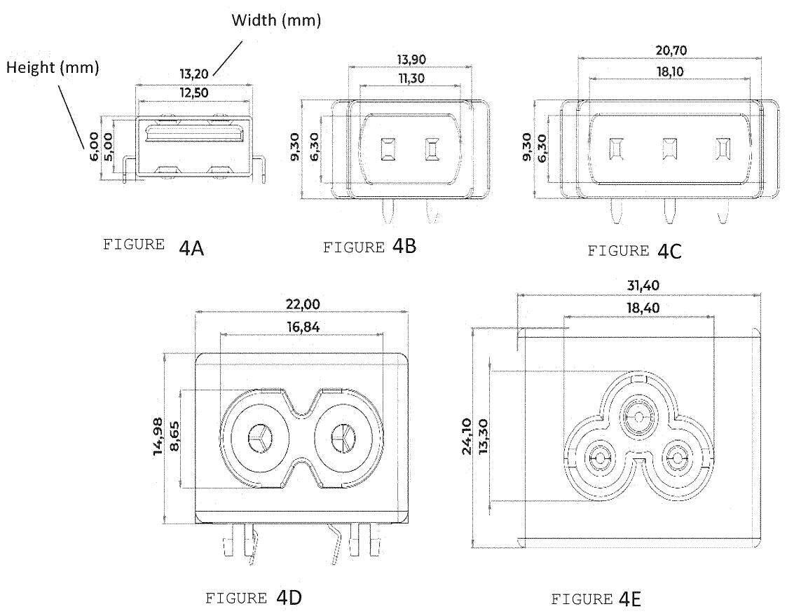

FIGS. 4A-D show the front views of USB-A port 4A, an example of a E4 micro-inlet 4B, another example of E2 micro-inlet 4C and an IEC C8 inlet 4D and an IEC C6 inlet 4E. The micro-couplers 4B, 4C have a height of about 9.3 mm while an IEC C8 inlet has a height of about 16 mm. So, visually, micro-inlets approach the small size and shape of a USB-A port.

The micro-couplers are now described in detail according to the following categories:
Vertical pin design,
Reinforced vertical pin design;
Horizontal pin design.

1. Vertical Pin

1.1 E3/E4 Ungrounded Micro-Coupler

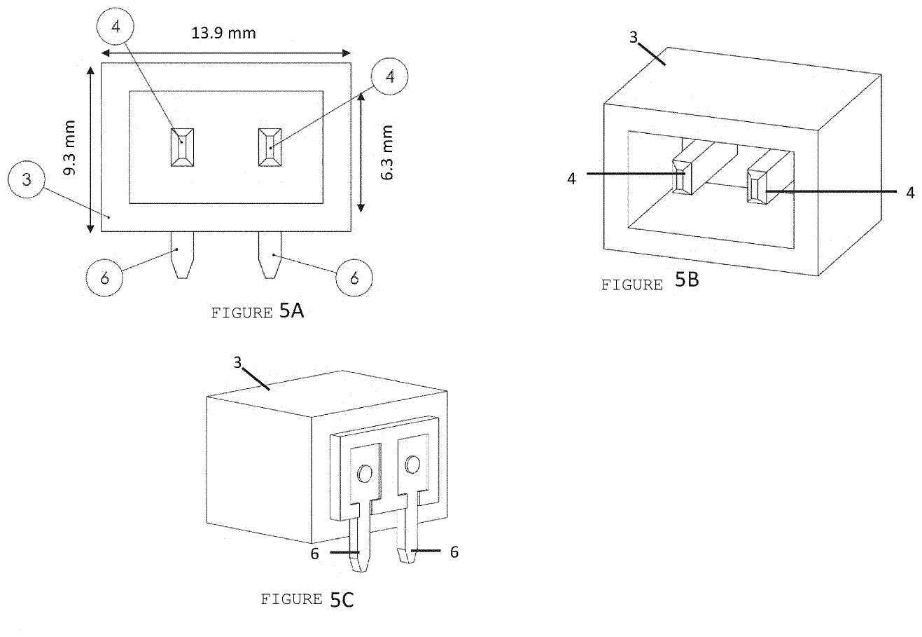

FIGS. 5A-C show a front view 5A, side view 5B and back axonometric view 5C of an E4 ungrounded power inlet, with vertical pin. The E4 power inlet is made of an external plastic housing 3, two conductive UN (line and neutral) pins 4 and two contact points 6. The housing 3 includes a recessed cavity and the two pins are arranged inside the recessed cavity.

In the example shown, the housing has a height and a width of about 9.3 mm and 13.9 mm respectively. However, the housing may have several other dimensions and has generally a maximum height of approximately 10 mm and a maximum width of approximately 14.5 mm when the micro-inlet includes two conductive pins.

In the example shown, the recessed cavity of the housing has a height and a width of about 6.3 mm and 11.3 mm respectively. More generally, the recessed cavity may have a maximum height of about 7 mm and a maximum width of about 12 mm when the micro-inlet includes two conductive pins.

The recessed cavity is shown to have a depth of about 9 mm. The cavity may have several other dimensions and has generally a maximum depth of about 10 mm.

The opening of the front surface of the housing is also shown to be generally rectangular with the height of the rectangular opening being less than approximately 7 mm. The generally rectangular opening may also refer to a rectangle with rounded corners or a rectangular with curved sides.

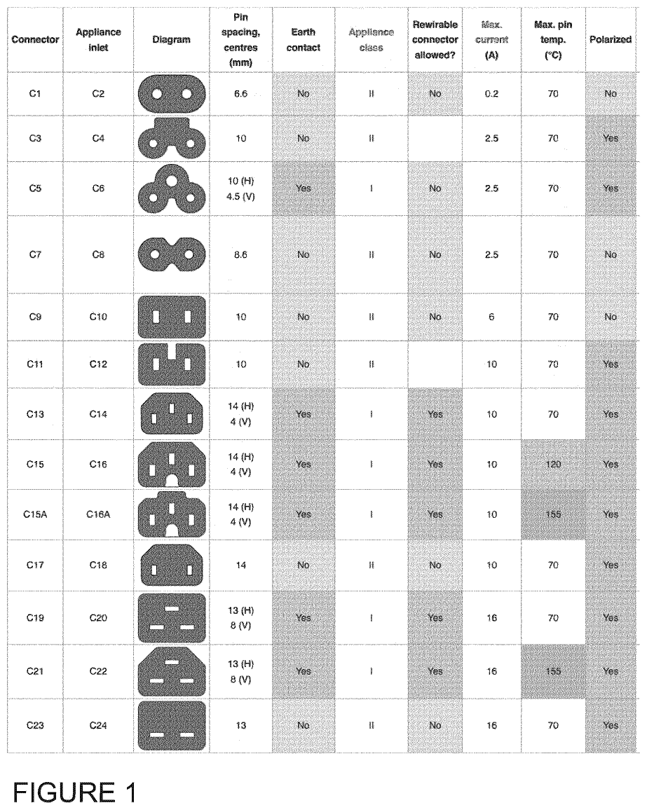

The opening may also include portions with different shapes, such as a circle, ellipse, triangle, hexagonal portions. The opening of the front of the housing may also be shaped substantially like any of the existing IEC 60320 inlets, as provided in FIG. 1.

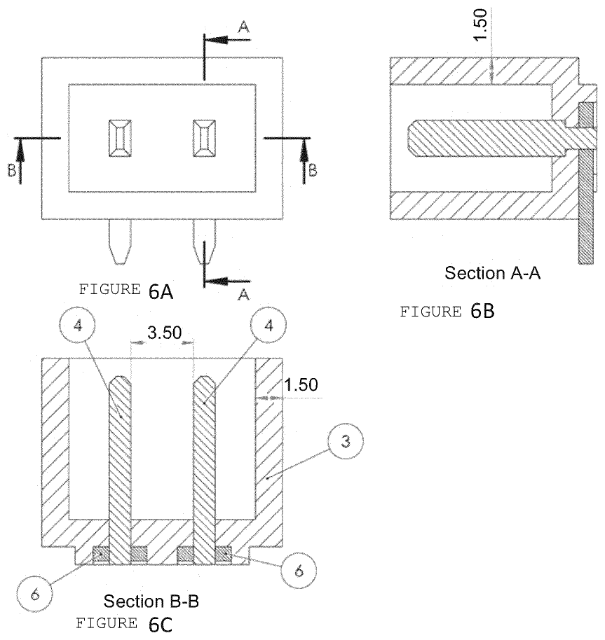

FIGS. 6A-C show a front view 6A of the E4 ungrounded power inlet, with cross section notation as well as its longitudinal (AA) cross section 6B and transverse (BB) cross section 6C. The minimum clearance distance between the pins is 3.5 mm, which is higher than the minimum required clearance distance as required by the IEC 60320 specification. The minimum thickness of the cavity walls is 1.5 mm as required by the IEC 60320 specification.

The L/N pins 4 protrude from a back wall of the recessed cavity and are configured to provide an electrical connection to the contact points 6. The contact points are configured to provide an electrical connection to an electrical device. The contact points 6 shown are attached or located near the bottom wall of the recessed cavity. The two pins 4 may therefore be riveted, soldered, or welded to the contact points 6.

The overall shape of the pins may be for example prismatic, with a truncated pyramidal termination. However, the pins may also have a flat or rounded termination and may take any other shapes. In the vertical pin design, the pins are oriented in parallel to the height of the housing of the power inlet.

The contact points 6 may generally be aligned with the pin orientation (horizontal soldering) or orthogonal to it (vertical soldering), according to the electronic circuitry the power inlet is attached to.

All the metal parts may be inserted in the housing, which gives mechanical strength to the whole structure; it also provides electrical insulation between the externally exposed cavity and the interior of the device.

The total height of the housing may also be shrunk down to approximately 9.3 mm, as a consequence of pin height and minimum clearance distance between the pins and the housing, and minimum thickness of the cavity walls. Pins' height and width are also chosen to provide both mechanical robustness and enough metal area for contacting the matching electrical contacts of the connector, with the minimum electrical resistance.

The total power inlet width shown is approximately 13.9 mm with the clearance distance between live and neutral pin set at 3.5 mm, even larger than the 3 mm clearance distance between pins stated by IEC 60320 regulations.

As a comparison, the IEC 60320 coupler with the smallest clearance distance between pins is the C1/C2 with 4.24 mm clearance distance between the pins. The C2 power inlet also has two pins and the width of the housing of C2 is equal to 19 mm. The housing of C2 also has a height of 13.5 mm. Hence the E4 power inlet shown in FIG. 5 is achieved with a substantially smaller height and width, and with a substantially smaller clearance distance between pins.

We can also compare the micro-inlet with the standard IEC 60320 C 10 power inlet that also includes a rectangular opening on the front surface of the housing. The height and width of the housing of the IEC 60320 C10 are 17.5 mm and 25.5 mm respectively. The clearance distance between pins is also 8 mm for the IEC 60320 C10. The E4 power inlet shown in FIG. 5 is achieved with a substantially smaller height and width, and with a substantially smaller clearance distance between pins.

Overall, the micro-inlet shown in FIGS. 5 and 6 has a housing with a volume of about 1016 mm³. The volume of the recessed cavity shown is about 640 mm³. More generally, the recessed cavity has a volume that is less than approximately 800 mm³. The housing has a volume that is less than approximately 1100 mm³. As a comparison, the IEC 60320 C8 power inlet has the most compact insertion mechanism and has a volume of about 2622 mm³ corresponding to about twice the volume of the housing of the E4 inlet.

The housing of the micro-inlet is made of an insulating material, such as plastic and has a mass of about 1.40 grams. The metal parts of the micro-inlet have a mass of about 0.9 grams and the conductive terminals each have a pin section of about 3 mm² As a comparison, the housing of the IEC 60320 C8 inlet has a mass of about 3.45 grams and the pins each have a section of about 4.4 mm². Again, the E4 inlet has a substantially lower mass than the IEC 60320 power inlets.

The housing is also shown to have a box-like shape. However, the housing may have several other geometrical shapes.

Advantageously, with a simple, box-like shape of the power inlet, any external feature can be easily added to the power inlet, without increasing the overall inlet's dimensions. For instance, the E4 power inlet can be mechanically integrated using features, such as stripes, located on the front of the power inlet (e.g., panel mounting) or on its sides (e.g., bank or snap mounting). When bank mounting is shifted towards the interior of the inlet, the external profile of the power inlet is not altered, which in turn reduces its visual impact. The inlet design and the corresponding electrical device design can therefore be sleek and minimalistic.

The same reasonings also apply for the electric integration of the power inlet, via the contact points, that can be designed according to either a horizontal or vertical orientation, combined with THT (through hole technology) or SMD (surface mount device) configurations, in this way, both vertical and 90 degrees soldering are possible.

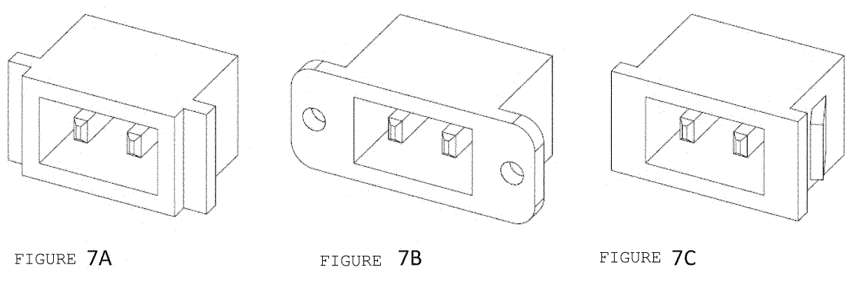

FIGS. 7A-C show various examples of the housing of the AC power inlet, and its mechanical integration or mounting within an electrical device; from left to right, bank 7A, panel 7B and snap mounting 7C.

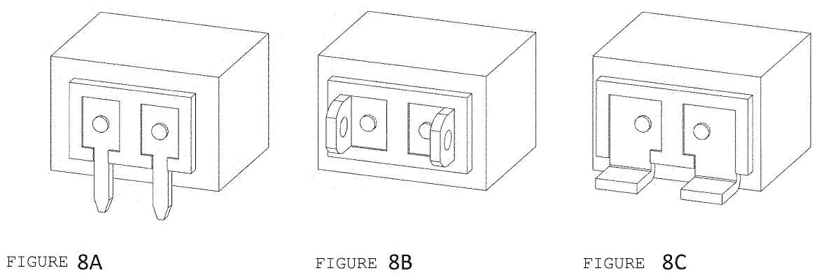

FIGS. 8A-C show various examples of the contact points of the AC power inlet, and their electric integration within a device; from left to right, horizontal THT 8A, vertical THT 8B and SMD 8C.

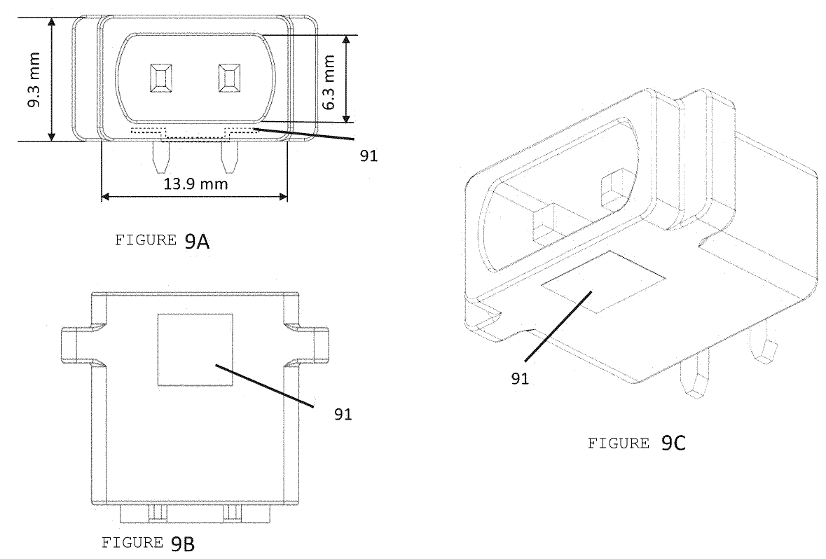

FIGS. 9A-C show the front view 9A, bottom view 9B and perspective view 9C of an example of an SMD configuration for the micro-inlet. Additionally, a soldering pad 91 is added at an exterior surface of the housing, to improve mechanical stability during the insertion of a matching female connector. If fewer soldering points are used instead, the power inlet may incline or lift while inserting an electrical cord, which in turn could significantly decrease the life cycle of the power inlet.

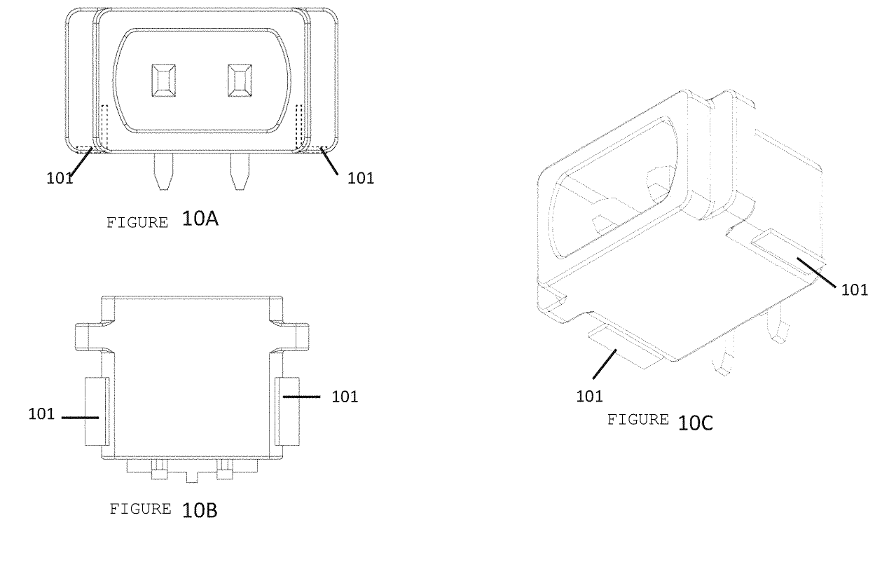

FIGS. 10A-C show the front view 10A, bottom view 10B and perspective view 10C of an example of another configuration for the micro-inlet, in which two plates 101 are located around the side of a surface of the housing, making the power inlet easy to solder.

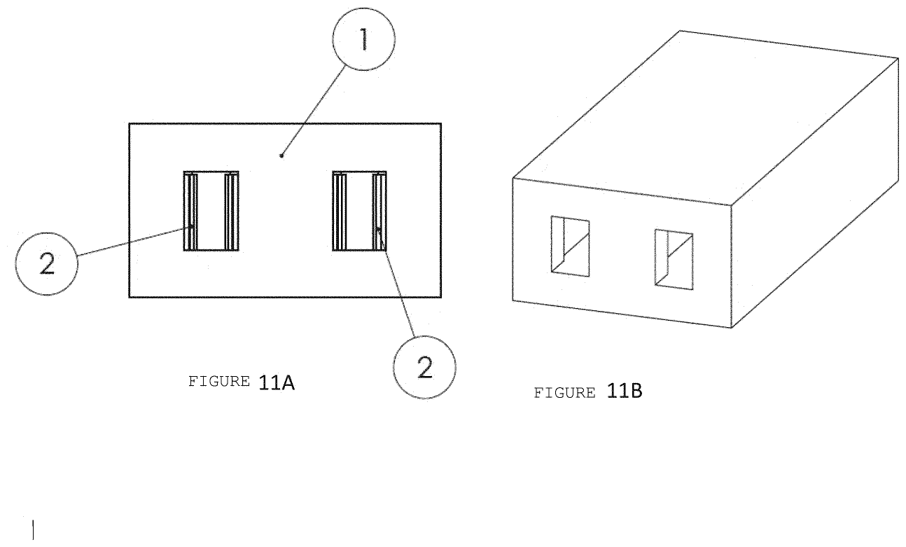

FIGS. 11A-B show the front view 11A and axonometric view 11B of an E3 ungrounded connector, implemented according to the vertical pin design. The E3 connector is composed of an insulated housing 1 and two electrical contacts or female contact socket 2 that are housed within the insulated housing 1.

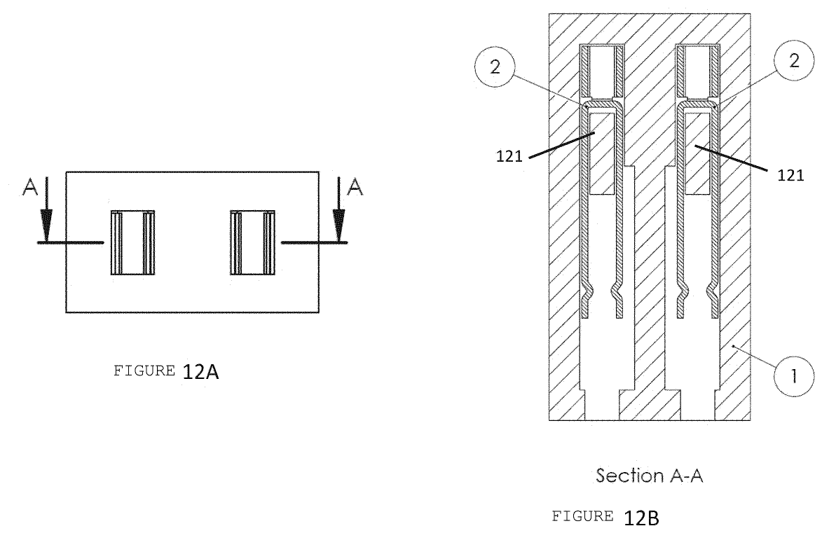

FIGS. 12A-B show the front view 12A and the longitudinal (AA) cross section 12B of the E3 ungrounded connector, implemented according to the vertical pin design.

The E3 connector is configured to be inserted inside an AC power inlet, such as the E4 power inlet. Hence the recessed cavity of the E4 power inlet and the housing of the E3 connector are shaped to substantially match one another.

Alternatively, the housing dimensions of the E3 connector may be slightly smaller than the dimension of the recessed cavity of the E4 power inlet to compensate for manufacturing imperfection; for this reason, a clearance of about 0.25 mm may be left on each side of the housing of the E3 connector as compared to the dimension of the recessed cavity of the corresponding power inlet E4.

In the example shown, the housing of the E3 connector has a height and a width of about 5.8 mm and 10.8 mm respectively, with the matching E4 inlet having a recessed cavity with a height of about 6.3 mm and a width of about 11.3 mm.

More generally, the housing of the E3 connector has a height that is less than 7 mm and a width that is less than approximately 12 mm.

The electrical contacts 2 are configured to allow just horizontal motion with respect to the height of the connector, with the aim of minimizing the amount of material on the vertical axis and thus making the connector thinner. The electrical contacts may also include one or more bending sections, improving mechanical stability when the connector E3 is inserted into the power inlet E4.

The connection between the power inlet E4 and the connector E3 is mechanically sustained by the electrical contacts in the connector, which are configured to attach to or to grab the pins on the matching power inlet.

A spring effect is also provided by the specific shape of the electrical contact. Each electrical contact may be made of a single piece of conductive material that is configured to widen during insertion of the connector, providing a robust connection between the power inlet and matching connector.

During the insertion process, the electrical contacts widen when one or more of the bending sections interfere mechanically with the pin; therefore, providing a stable connection and electrical bridging between the connector and power inlet.

Alternatively, a rigid insulating element 121 may be added, to provide mechanical stability and keep the two branches of an electrical contact aligned. The rigid insulating element 121 also acts as mechanical stop for the electrical contacts during a connector removal from the power inlet.

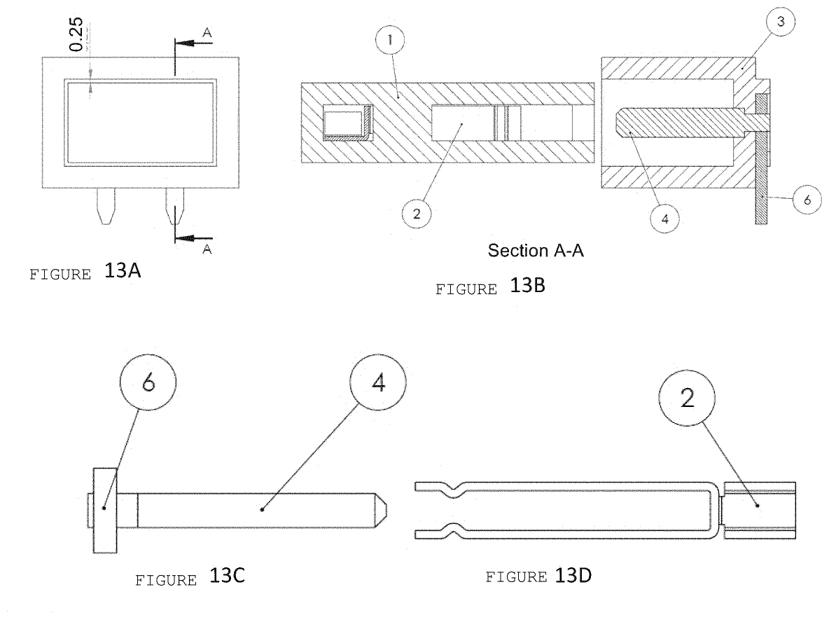

FIG. 13A shows a front view of an E3 connector inserted into the E4 power inlet 11A, according to the vertical pin design. FIG. 13B shows a longitudinal (AA) section of E3 connector and of an E4 power inlet facing one another before being connected. FIG. 13C shows a pin 4 and contact points 6 of the E4 power inlet. FIG. 13D shows an electrical contact 2 of the connector.

The shape and/or number of bending sections and the location of the bending sections on the electrical contacts may be adjusted according to a desired mechanical stability, without any significant impact on the power inlet design. The design of electrical contacts therefore benefits from a high degree of freedom. The design of electrical contacts may also be determined to reduce the overall width of a micro-connector.

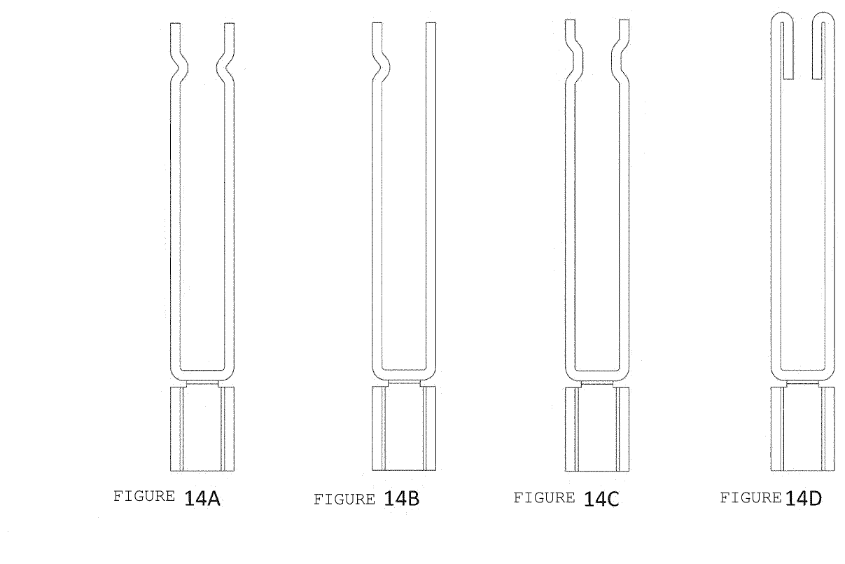

FIGS. 14A-14D show several variations of the electrical contact of the micro-connector, including symmetrical point-like bending 14A, single point-like bending 14B, planar bending 14C, and terminal bending 14D.

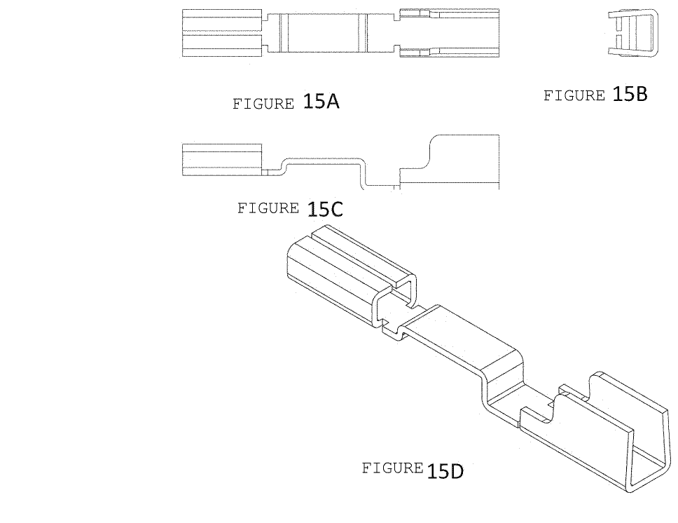

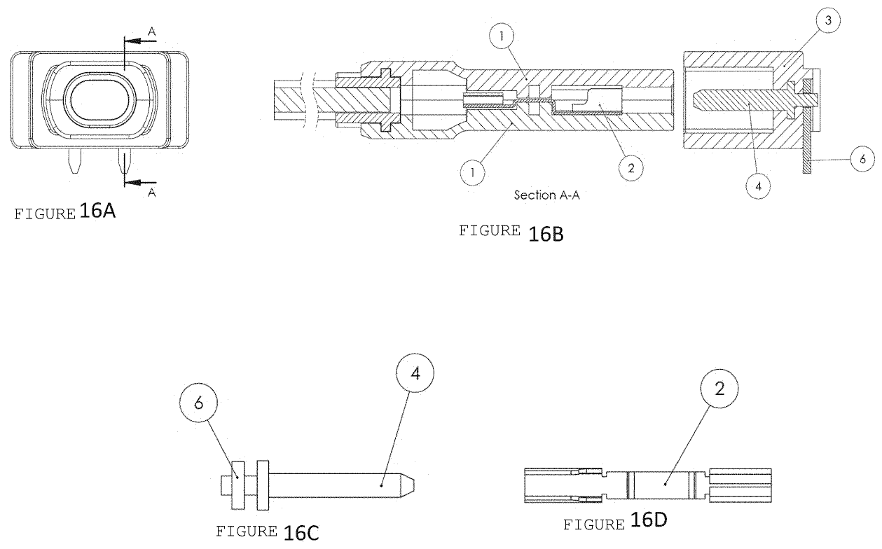

FIGS. 15A-D and FIGS. 16A-D show different views of another example of electrical contact design.

The micro-coupler architectures may also be implemented to the design of an extension cord, which exhibits male and female terminations at its opposite ends.

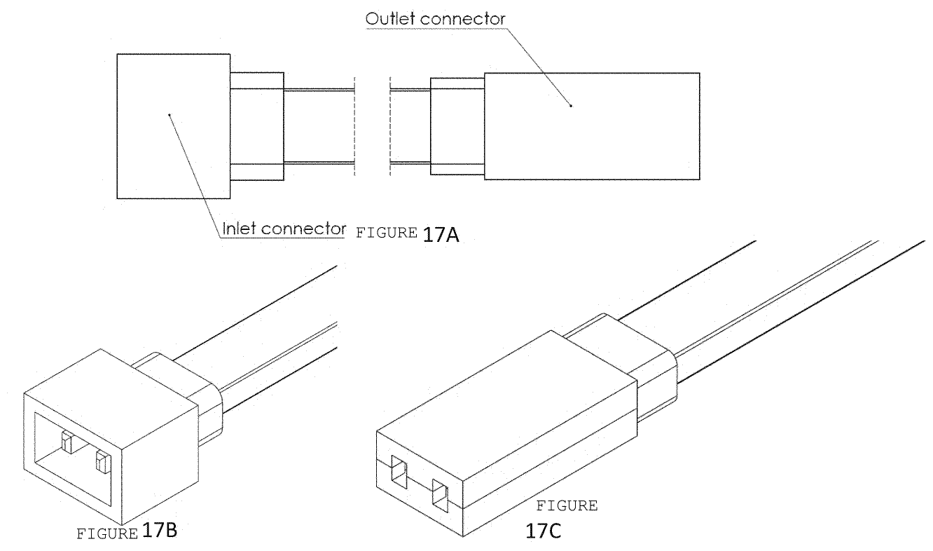

FIGS. 17A-17C show an example of a female-male cable 17A including a male inlet 17B connected at one end and a female connector 17C at the other end.

The design considerations and variations described above are also applicable to the following sections.

1.2 E1/E2 Grounded Micro-Coupler

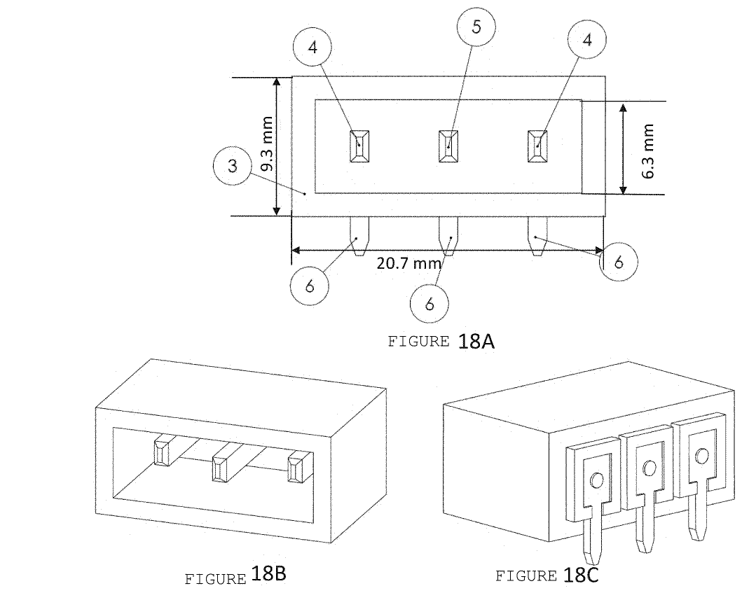

FIGS. 18A-C show a front view 18A, side axonometric view 18B and back axonometric view 18C of the E2 grounded power inlet, implemented according to a vertical pin design. Four major elements are identified: external housing 3, L/N pins 4, earth pin 5 and contact points 6. The housing includes a recessed cavity with the three pins being arranged inside the recessed cavity.

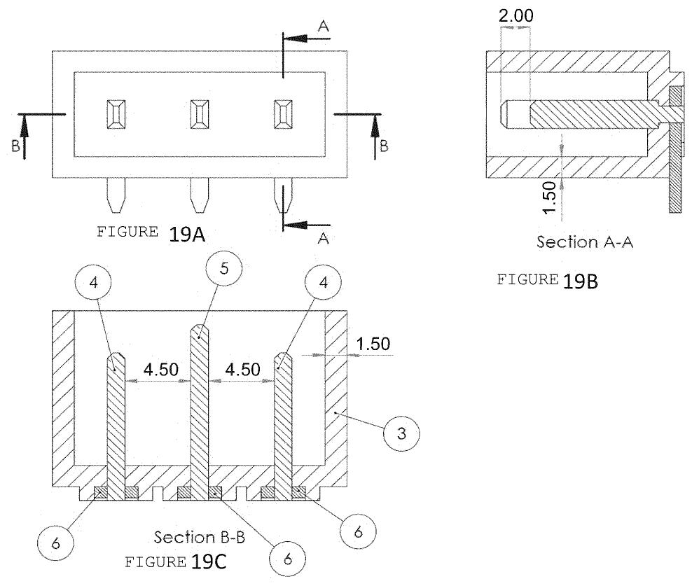

FIGS. 19A-C show a front view of the E2 micro-inlet 19A, with section notation; longitudinal (AA) section 19B and transverse (BB) section 19C of the E2 micro-inlet, implemented according to the vertical pin design. The minimum clearance distance between the earth pin and a live or neutral pin is 4.5 mm.

The earth pin is 2 mm longer than the L/N pins, so that it is the first pin that contacts the corresponding female socket of the matching connector during insertion of the connector. The earth pin is also the last pin to be electrically disconnected during the removal of a connector; in that way, maximum electrical safety is provided.

The three conductive terminals, mainly the UN pin as well as the earth pin, are coplanar and aligned horizontally along the width of the housing. The height of the housing of the grounded power inlet is also less than approximately 10 mm. In the example provided, the total height of the housing is about 9.3 mm.

The housing of the E2 micro-inlet shown is also made of an insulating material, such as plastic and has a mass of about 2.1 grams. As a comparison, the housing of the IEC 60320 C6 inlet has a mass of about 3.85 grams. Hence E2 inlet also has a substantially lower mass than the IEC 60320 power inlets.

Overall, the housing of the micro-inlet shown in FIGS. 18 and 19 has a volume of about 1540 mm³ and the recessed cavity has a volume of about 1004 mm³. More generally, the housing of the micro-inlet has a maximum volume of approximately 1650 mm³. The recessed cavity has a maximum volume of approximately 1100 mm³.

The presented micro-inlet shown has an housing with an overall width of about 20.7 mm. The minimum clearance distance between live/neutral and earth pin is 4.5 mm, even larger than 4 mm stated by IEC 60320.

The housing of the E2 micro-inlet may have several other dimensions and has generally a maximum height of approximately 10 mm and a maximum width of approximately 22 mm.

The recessed cavity is shown to have a depth of about 11 mm. The cavity generally has maximum depth of about 12 mm.

The recessed cavity of the E2 micro-inlet shown has a height of about 6.3 mm and a width of about 18.1 mm. More generally, the recessed cavity of the E2 micro-inlet shown has a height that is less than approximately 7 mm and a width of about 19 mm.

The coplanar arrangement of the three pins is substantially different from the pin arrangement in current IEC 60320 couplers. Usually, the earth pin is located above the live and neutral pins, such as for the C13/C14 couplers, which significantly increases the overall height of the couplers.

The matching E1 female connector comprises an external plastic housing 1 and three electrical contacts 2.

Additionally, the electrical contacts may be identical for both earth and L/N pins, thus the connector design may be totally modular, when moving from the ungrounded version to the grounded one.

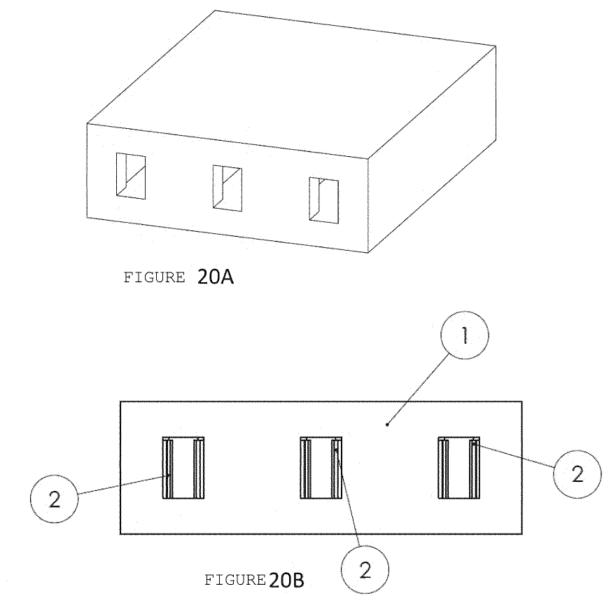

FIGS. 20A-19B show an axonometric view 20A and front view 20B of the E1 grounded connector, implemented according to the vertical pin design and including an external case or housing 1 and electrical contacts 2.

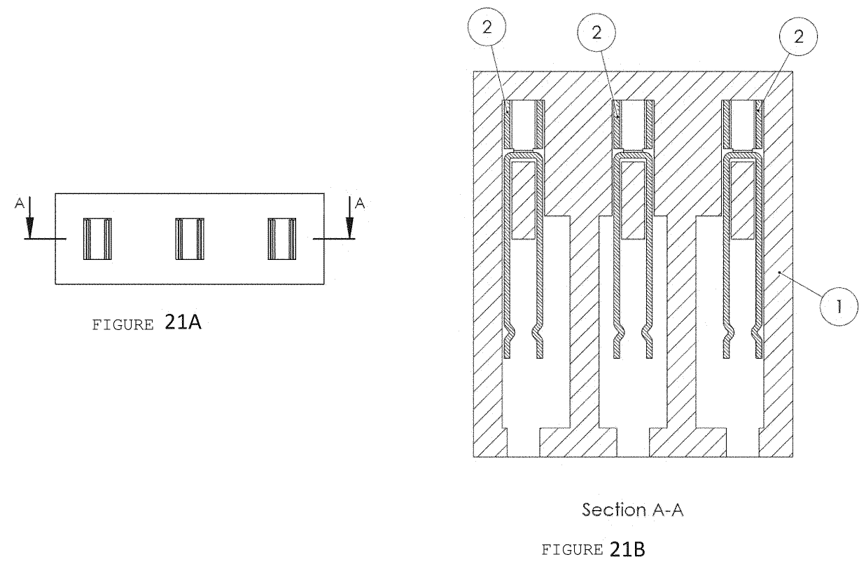

FIGS. 21A-21B show a front view 21A and the longitudinal (AA) section 19B and of the E1 grounded connector, implemented according to the vertical pin design.

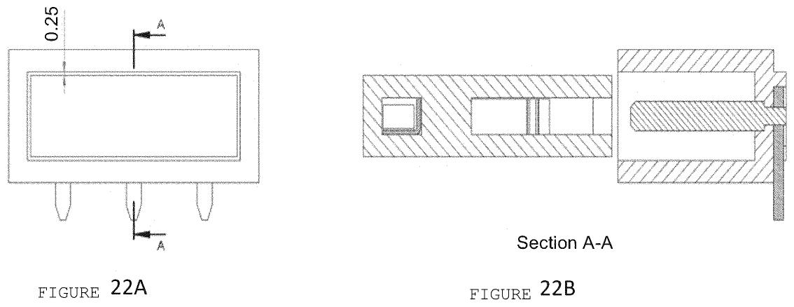

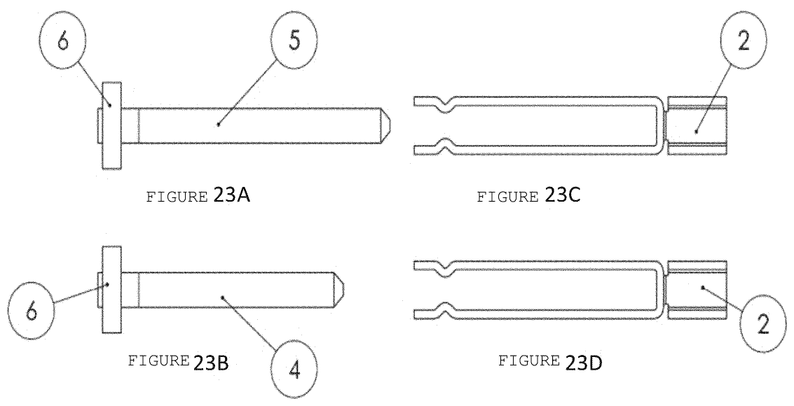

FIG. 22A shows a front view of an E1 connector inserted into the E2 power inlet, according to the vertical pin design. FIG. 22B shows a longitudinal (AA) section of E1 connector to be inserted into the E2 power inlet. FIGS. 23A-D respectively show a pin 4 of the power inlet 23A, the earth pin of the power inlet 23B and contact points 23C, 23D of the E2 power inlet.

In the example shown, the housing of the E1 connector has a height and a width of about 5.8 mm and 17.7 mm respectively.

Again, the E1 connector is configured to be inserted inside the E2 power inlet. Hence the E1 connector has a housing with a shape that is configured to substantially match the dimension of the recessed cavity of the E2 power inlet.

2. Reinforced Vertical Pin

2.1 E3/E4 Ungrounded Micro-Couplers

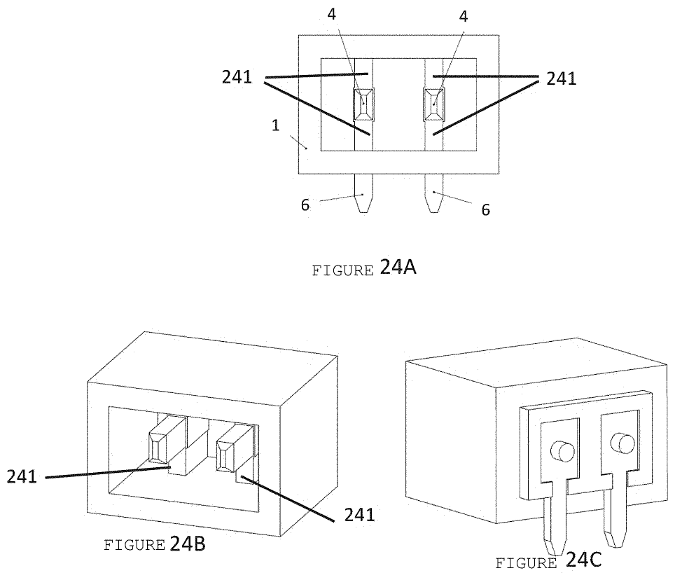

FIGS. 24A-C show a front view 24A, axonometric views 24B and 24C of the E4 ungrounded power inlet, implemented according to a reinforced vertical pin design.

The reinforced E4 power inlet represents an alternative design of the E4 power inlet and includes an additional vertical support section 241 at the base of each pin. The support sections shown are orthogonal to the pins and adjacent to the bottom wall of the recessed cavity.

These additional support sections 241 may be made of the same insulating material as the housing; hence the housing and support sections can be moulded together as a single insulating piece item.

The dimension or location of the support sections can be adjusted to improve the mechanical stability of the pin. As an example, the overall depth of the support section is about one half of the pin length.

The dimensions of the reinforcing structure can be optimised using simulation methods, for instance to compute the maximum tolerated vertical force applied to the pin, as a function of a number of geometrical parameters.

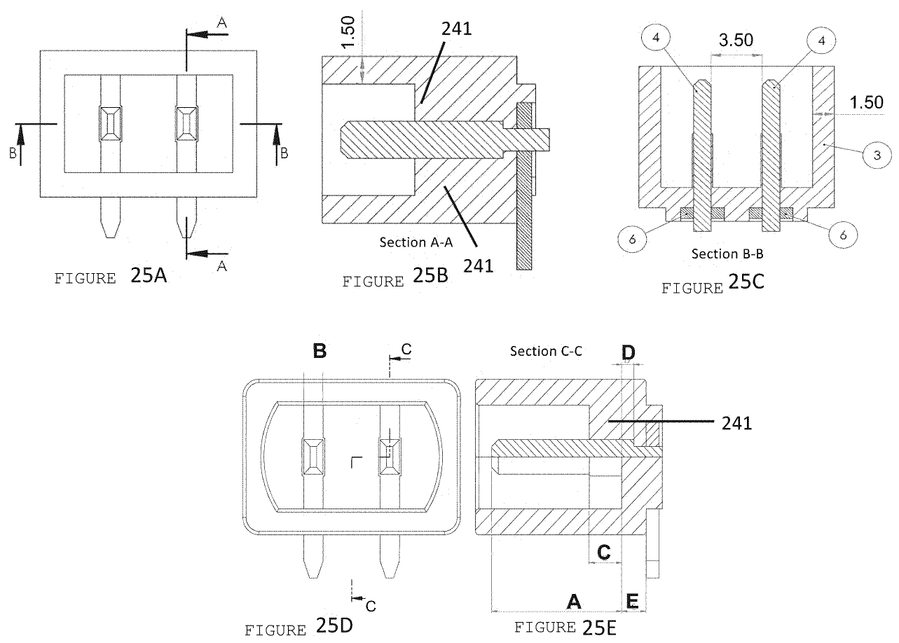

FIG. 25D shows another example of an E4 power inlet with a reinforced pin design, with cross section notation (CC). FIG. 25E shows the corresponding cross section (CC). FIGS. 25D-E show parameters that can be optimised while performing a stress analysis method: length of pin section (A), pin width (B), depth of support section (C), length of the pin section within the back wall of the housing (D) and total thickness of the back wall of the housing (E). For example, considering all the dimensions parametrized in y, the stress analysis method determined the following optimised dimensions: A=32y, B=6y, C=16y, D=3y and E=6y. As an example, y may be equal to approximately 0.25 mm in the presented configuration.

An advantage of the reinforced E4 power inlet is an improved robustness while keeping the small form factor of the E4 power inlet as described earlier.

Additionally, the dimension of the support section impacts the design of the matching E3 connectors: recessed holes are added to the E3 connector which are configured to match the support sections of the reinforced E4 power inlet, leading to a fork-like structure.

When adjusting the dimensions of the vertical support sections, the coupler system needs to be designed as a whole, in order to determine the best combination of stability and mechanical robustness.

FIGS. 25A-C show a front view of the E4 ungrounded power inlet with a reinforced pin design, with section notation and the corresponding longitudinal (AA) section 25B and transverse (BB) section 25C.

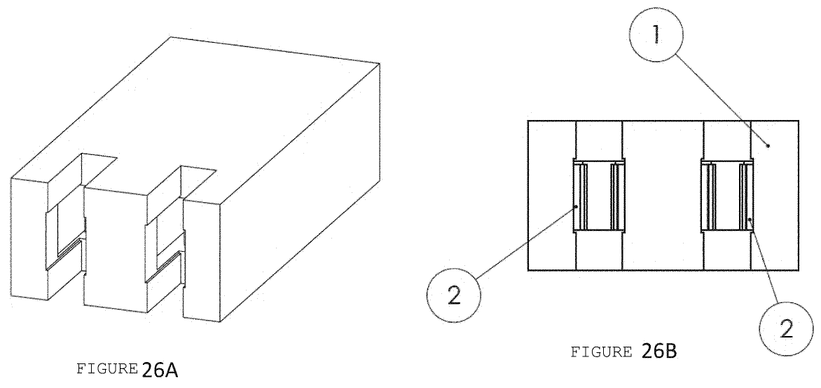

FIGS. 26A-B show a perspective view 26A and front view 26B of the matching E3 ungrounded connector, also implemented according to the reinforced vertical pin design.

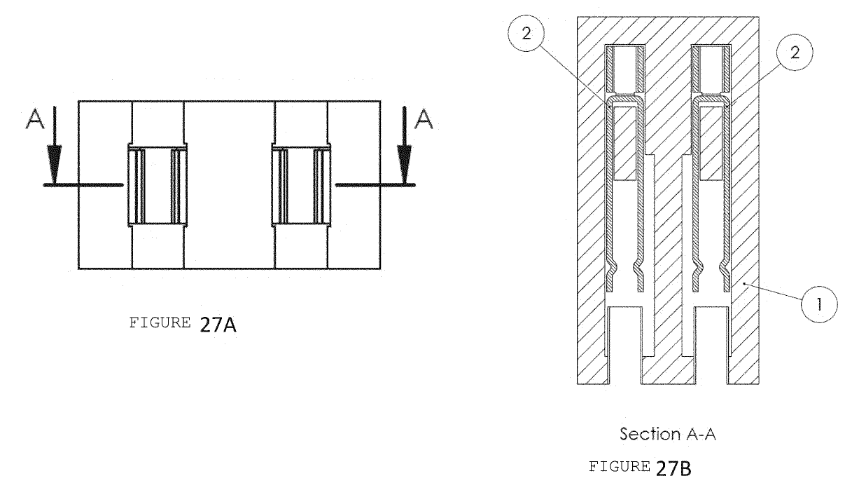

FIGS. 27A-B show a front view of the E3 ungrounded connector with section notation 27A and the corresponding longitudinal (AA) section 27B.

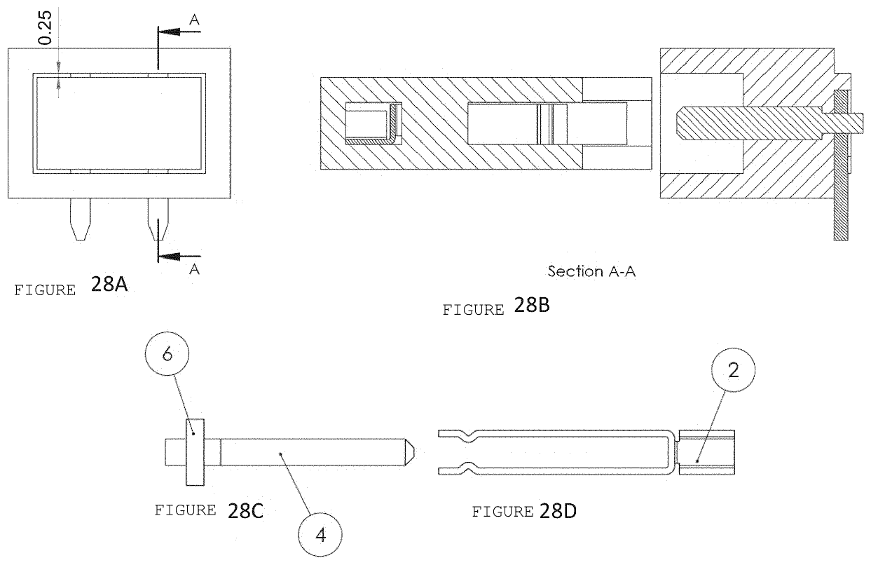

FIG. 28A shows a front view of an E3 connector inserted into the E4 power inlet 28A, according to the reinforced vertical pin design. FIG. 28B shows a longitudinal (AA) section of E3 connector to be inserted into the E4 power inlet. FIG. 28C shows a conductive pin 4 and contact points 6 of the E4 power inlet. FIG. 28D shows an electrical contact 2 of the connector.

2.2 E1/E2 Grounded Micro-Couplers

For the reinforced design, the grounded power inlet includes an additional vertical insulating section that is configured to support the earth pin.

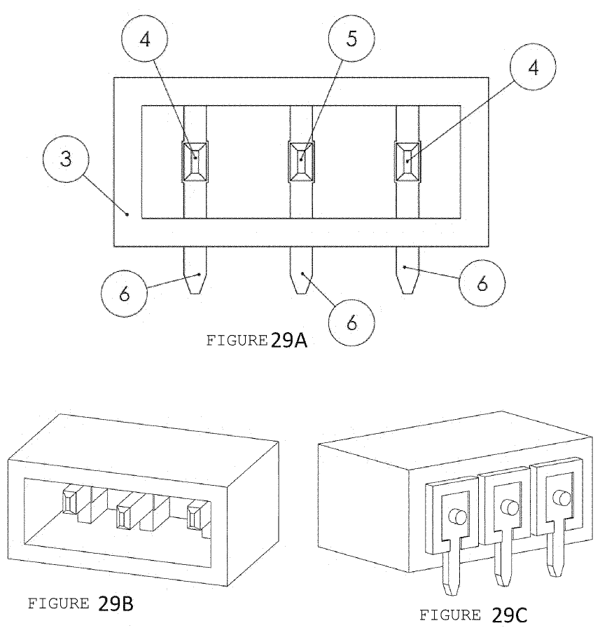

FIGS. 29A-C show a front view 29A, a side perspective view 29B and a back perspective view 29C of a E2 grounded power inlet with a reinforced vertical pin design.

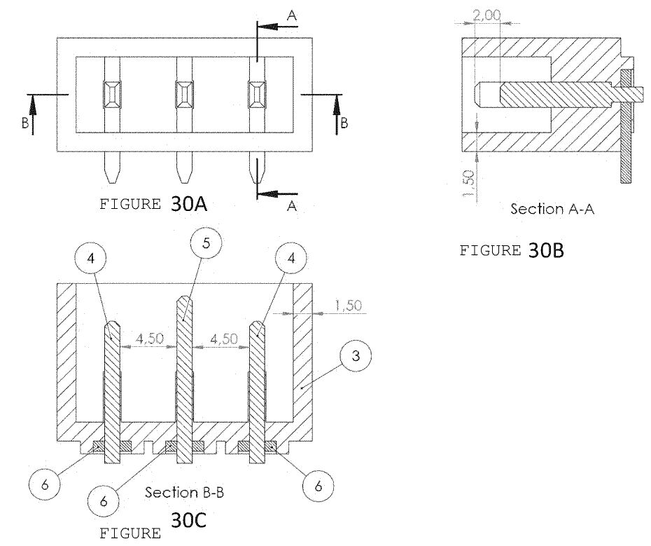

FIGS. 30A-C show a front view of the E2 grounded power inlet 30A, with section notation and the corresponding longitudinal (AA) section 30B and transverse (BB) section 30C of the E2 micro-inlet, implemented according to the reinforced vertical pin design.

An advantage of the reinforced E2 grounded power inlet is an improved robustness while keeping the small form factor of the E2 grounded power inlet without the reinforced vertical pins.

Similarly, the matching female connector E1 exhibits a fork-like shape, with three vertical cuts.

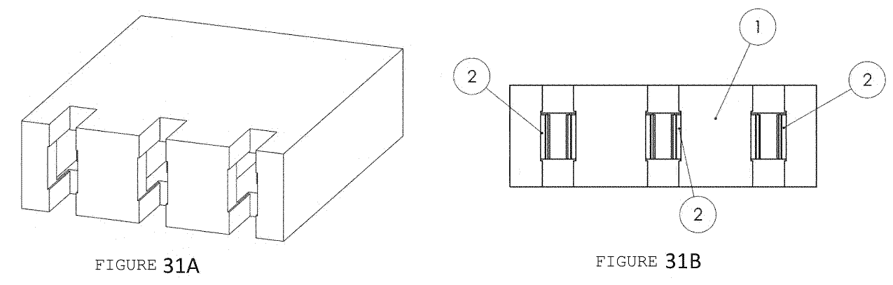

FIGS. 31A-B show a perspective view 31A and front view 31B of the matching E1 grounded connector.

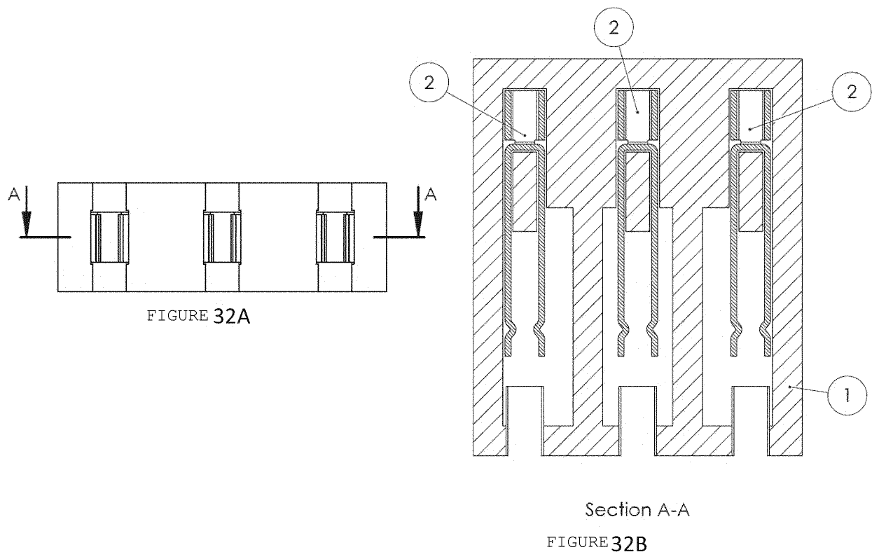

FIGS. 32A-B show a front view of the E1 grounded connector 32A, with section notation and the corresponding longitudinal (AA) section 32B.

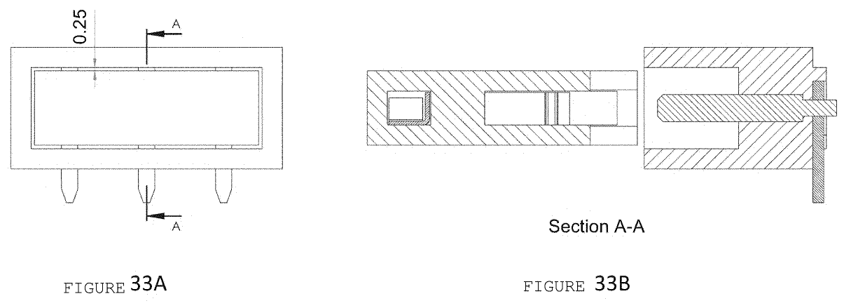

FIG. 33A shows a front view of an E1 connector inserted into the E2 power inlet, according to the reinforced vertical pin design. FIG. 33B shows a longitudinal (AA) section of E1 connector to be inserted into the E2 power inlet.

3. Horizontal Pin

3.1 E3/E4 Ungrounded Micro-Couplers

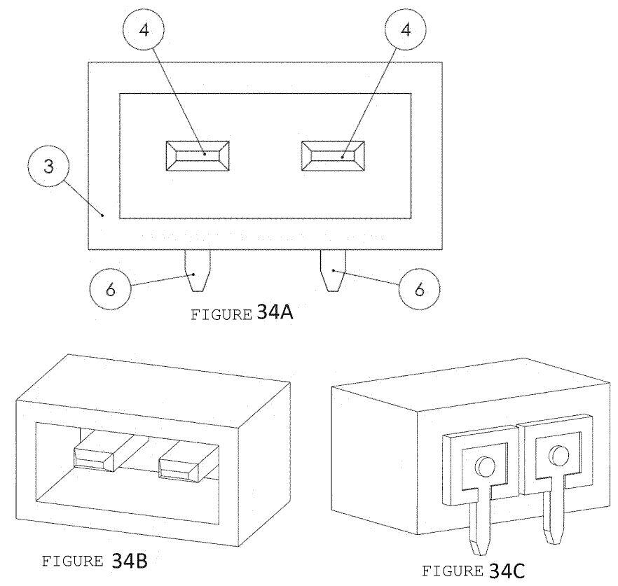

FIGS. 34A-C show a front view 34A, side perspective view 34B and back perspective view 34C of the E4 ungrounded power inlet, implemented according to the horizontal pin design and including an external housing (3), L/N pins (4) and contact points (6).

As compared to the vertical pin configuration, the live/neutral pins of the power inlet have undergone a 90-degree rotation, such that they are aligned horizontally to the width of the housing.

The housing of the power inlet shown has a height of approximately 9 mm and a width of approximately 17 mm due to the horizontal orientation of the pins and the required clearance distance between pins. Generally, the housing of the E4 ungrounded power inlet with a horizontal pin design may have a height that is less than approximately 10 mm, and a width that is less than approximately 18 mm.

The recessed cavity of the power inlet shown has a height of approximately 6 mm and a width of approximately 14 mm due to the horizontal orientation of the pins and the required clearance distance between pins. Generally, the recessed cavity of the E4 ungrounded power inlet with a horizontal pin design may have a height that is less than approximately 7 mm, and a width that is less than approximately 15 mm.

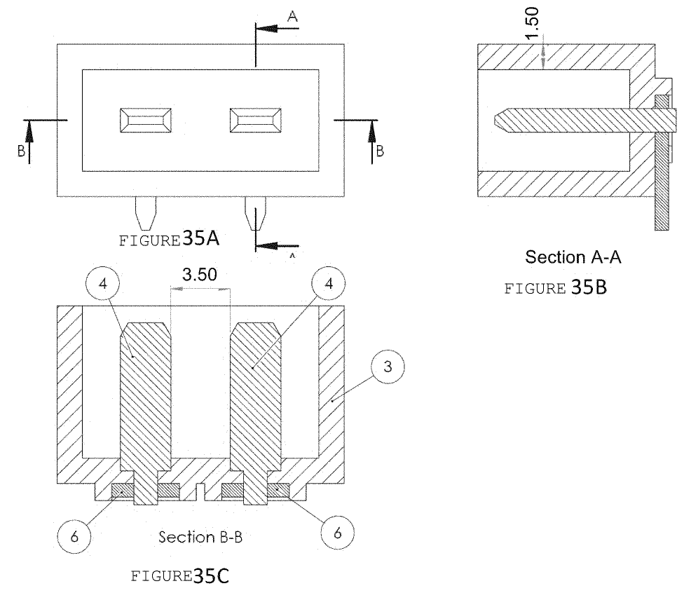

FIGS. 35A-C show a front view of the E4 ungrounded power inlet 35A, with section notation and the corresponding longitudinal (AA) section 35B and transverse (BB) section 33C with the E4 ungrounded power inlet configured with a horizontal pin design.

With the horizontal design, the matching electrical contacts of the corresponding connector are also rotated by 90 degrees.

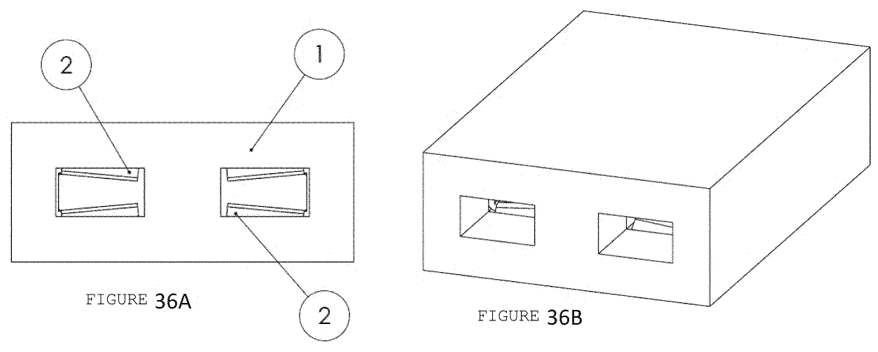

FIGS. 36A-B show a front view 36A and a perspective view 36B of the matching E3 ungrounded connector, implemented according to the horizontal pin design. The matching E3 connector includes a housing or external case 1 and electrical contacts 2.

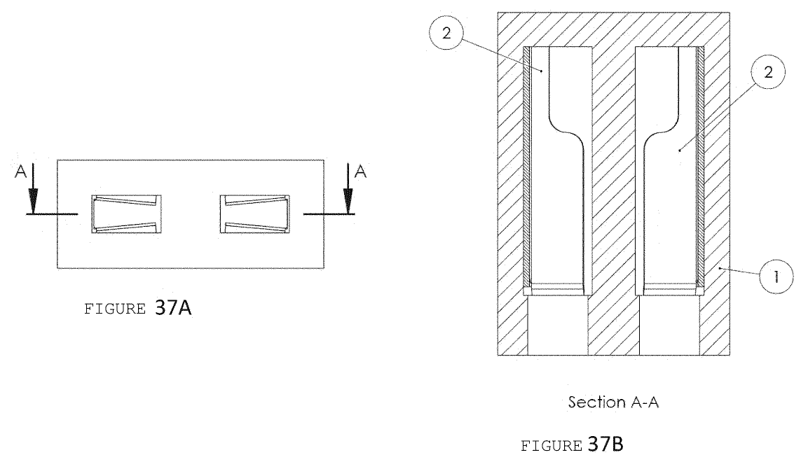

FIGS. 37A-B show a front view 37A of the matching E3 ungrounded connector with a horizontal pin design, with section notation and the corresponding longitudinal (AA) section 37B.

In the example shown, the housing of the E3 ungrounded connector with a horizontal pin design has a height and a width of about 5.5 mm and 13.5 mm respectively. Generally, the housing of the E3 ungrounded connector with a horizontal pin design may have a height that is less than approximately 6 mm, and a width that is less than approximately 14 mm.

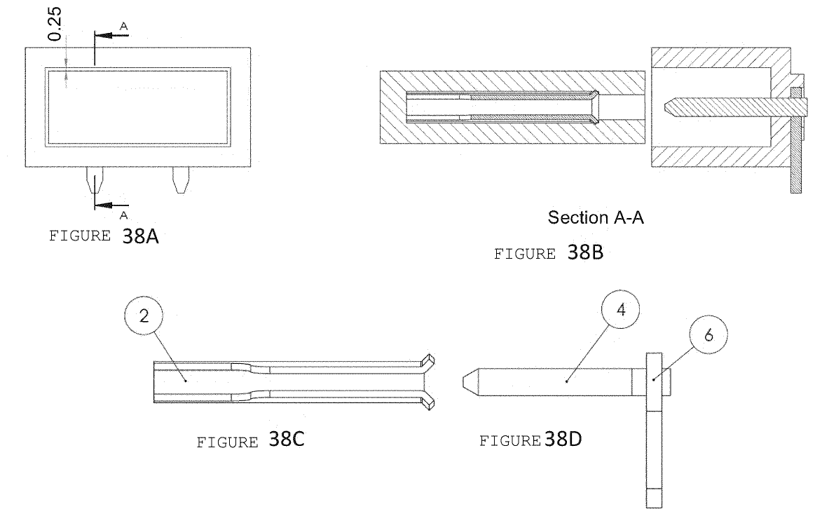

FIG. 38A shows a front view of the E3 connector inserted into the E4 power inlet, according to the horizontal pin design. FIG. 38B shows a longitudinal (AA) section of an E3 connector and an E4 power inlet facing each other. FIGS. 38C-D show an electrical contact 38C of the E3 connector and a conductive pin 38D of the E4 power inlet.

3.2 E1/E2 Grounded Micro-Couplers

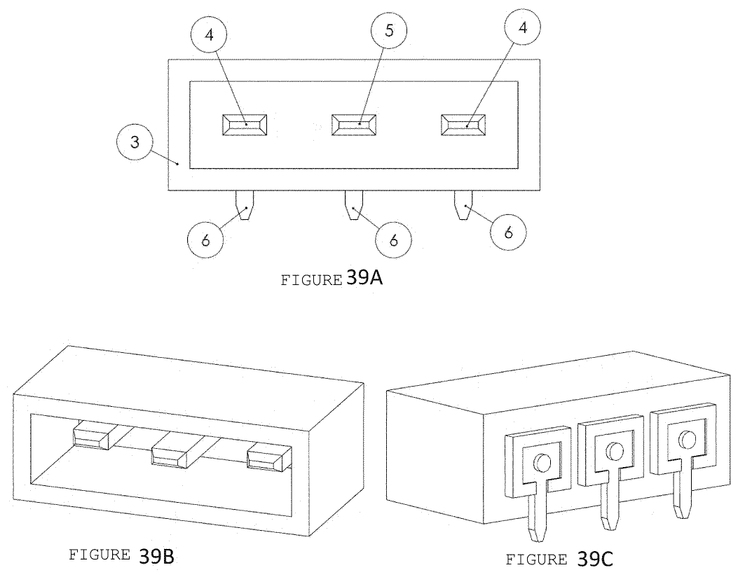

FIGS. 39A-C show a front view 39A, side perspective view 39B and back perspective view 39C of the E2 grounded power inlet, according to the horizontal pin design and including an external housing (3). L/N pins (4) and contact points (6).

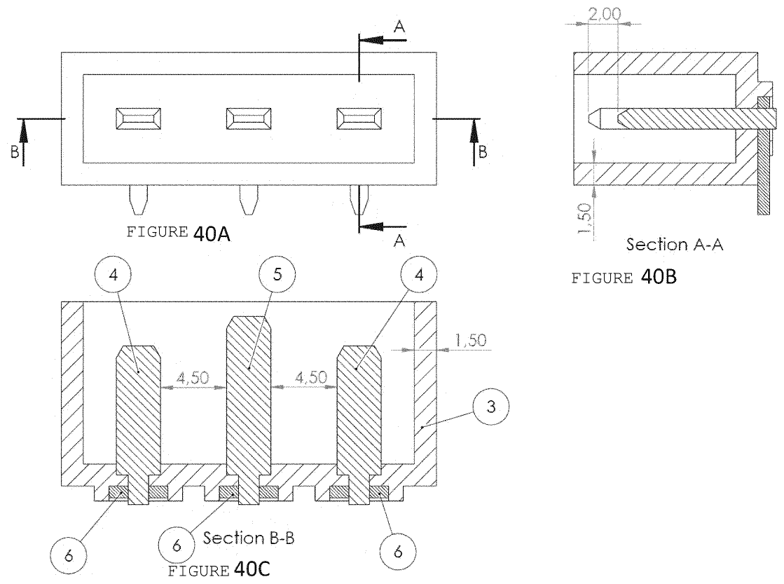

FIGS. 40A-C show a front view of the E2 grounded power inlet 40A, with section notation and the corresponding longitudinal (AA) section 40B and transverse (BB) section 40C of the E2 power inlet, according to the horizontal pin design.

The grounded power inlet E2 is obtained by a simple juxtaposition of the earth pin in between the neutral and live pins, with the three pins being aligned horizontally along the width of the housing.

As a result, the housing of the power inlet shown has a width of approximately 25.5 mm. Generally, the housing of the E2 grounded power inlet has a maximum width of approximately 26 mm.

The housing of the power inlet shown has a height of approximately 9 mm. Generally, the housing of the E2 grounded power inlet has a maximum height of approximately 10 mm.

The recessed cavity of the E2 grounded power inlet has a height of approximately 6 mm and a width of approximately 22.5 mm. Generally, the recessed cavity of the E2 grounded power inlet with a horizontal pin design may have a height that is less than approximately 7 mm, and a width that is less than approximately 23 mm.

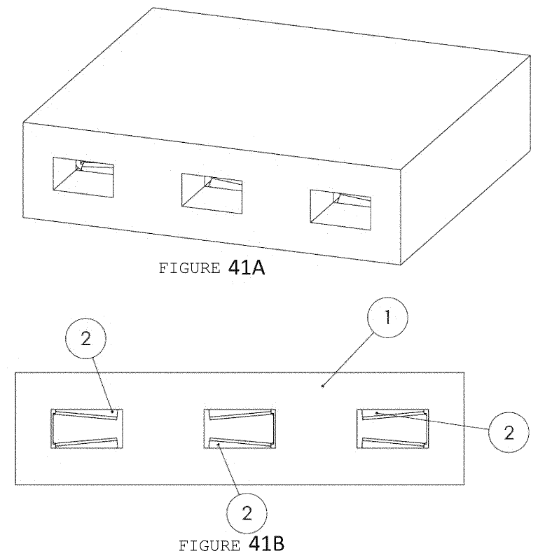

FIGS. 41A-B show a perspective view 41A and front view 41B of the matching E1 grounded connector, implemented according to the horizontal pin design.

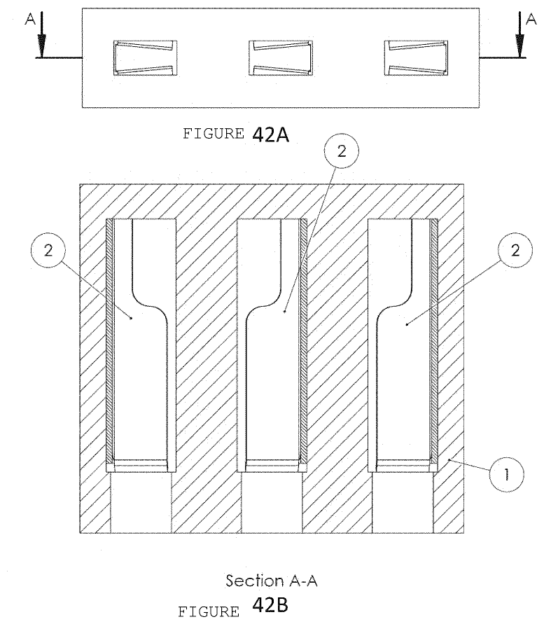

FIGS. 42A-B show a front view of the E1 grounded connector 42A, with section notation, and the corresponding longitudinal (AA) section 42B of the E1 grounded connector, implemented according to the horizontal pin design.

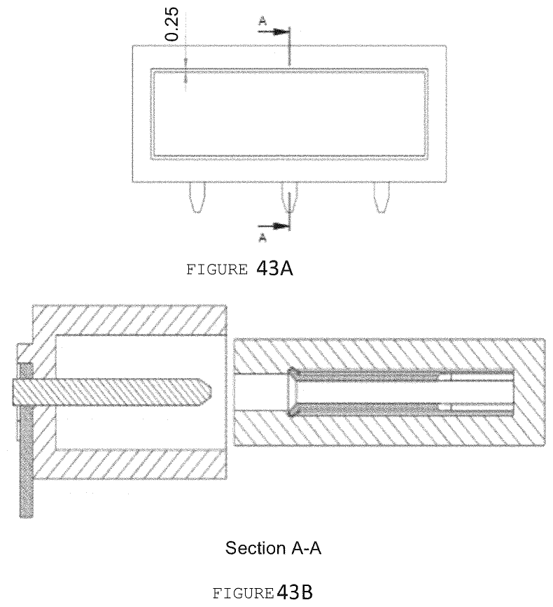

FIG. 43A shows a front view of the E1 connector inserted into the E2 power inlet, according to the horizontal pin design. FIG. 43B shows a longitudinal (AA) section of the E1 connector and E2 power inlet separated and facing each other.

In the example shown, the housing of the E1 grounded connector with a horizontal pin design has a height and a width of about 5.5 mm and 22 mm respectively. Generally, the E1 grounded connector with a horizontal pin design may have a height that is less than approximately 6 mm, and a width that is less than approximately 22.5 mm.

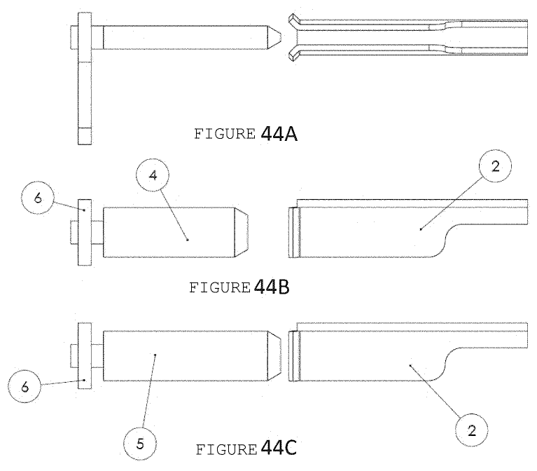

FIGS. 44A-C show different views of a pin and matching electrical contact, distinguishing between live/neutral pin and earth pin (longer).

Device Integration of the Micro-Couplers

Several examples of micro-couplers implemented as part of a device are now described.

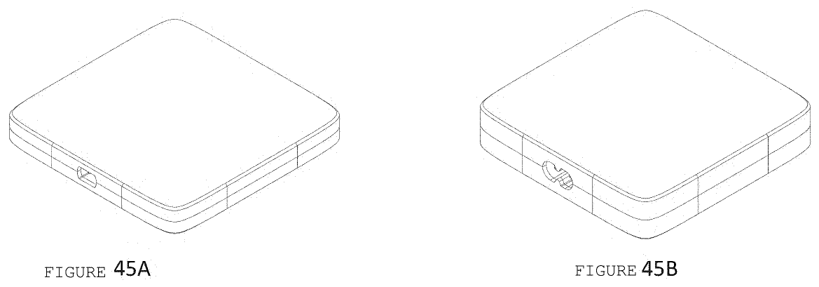

FIGS. 45A-B show an example of a desktop power supply with an integrated micro-inlet 45A and the desktop power supply integrated with a standard IEC C8 inlet 45B.

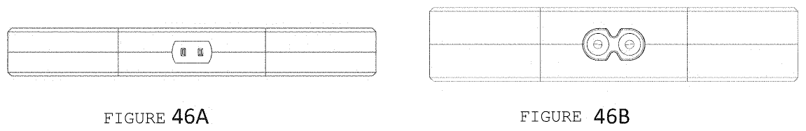

FIGS. 46A-B show side views of the desktop power supply with an integrated micro-inlet 46A and the desktop power supply integrated with a standard IEC C8 inlet 46B.

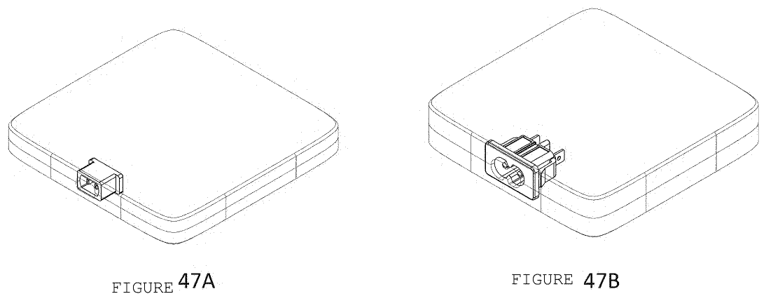

FIGS. 47A-B show perspective views of the desktop power supply with an integrated micro-inlet 47A and the desktop power supply integrated with a standard IEC C8 inlet 47B, comparing the encumbrance of the two connectors.

A height reduction of the power supply from 20 mm to 13 mm is achieved as a result of the integration with the micro-inlet as described above. A significant difference in the volume occupation of the micro-inlet when integrated inside the device is also achieved as shown in FIG. 47.

As a result, the power supply appears flat and sleek, and is also easier to be carried around or inserted in the pocket of a laptop bag for example.

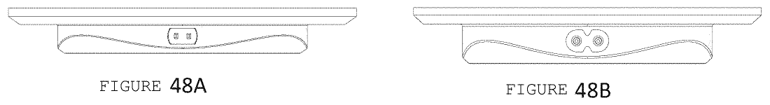

FIGS. 48A-B and 49A-B show another example of a micro-inlet integrated with a wireless charger with AC input and compared to the one equipped with standard IEC C8 inlet.

As a second implementation of the micro-inlet configuration, a wireless power transmitter is now represented; since the considered device is meant to be integrated below furniture panels or wall coverings, the small thickness represents one the key features of the product itself.

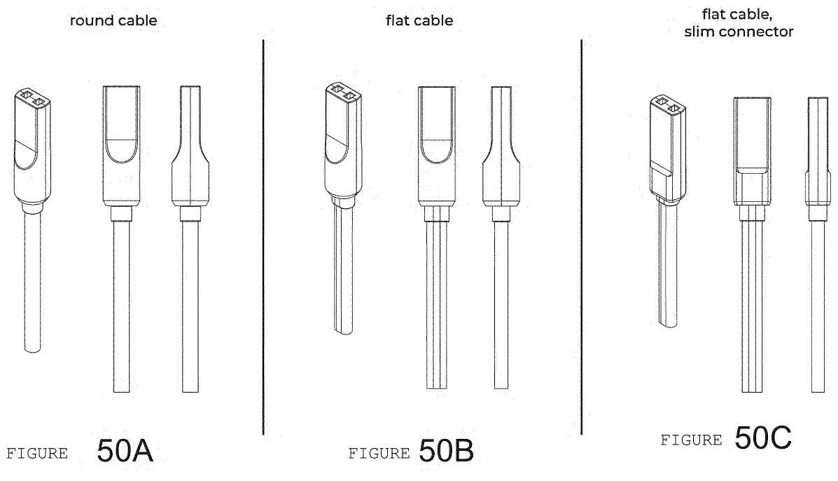

FIGS. 50A-50C provide examples of cables in which one end of the cable includes a female micro-connector that is configured to be inserted into a micro-inlet.

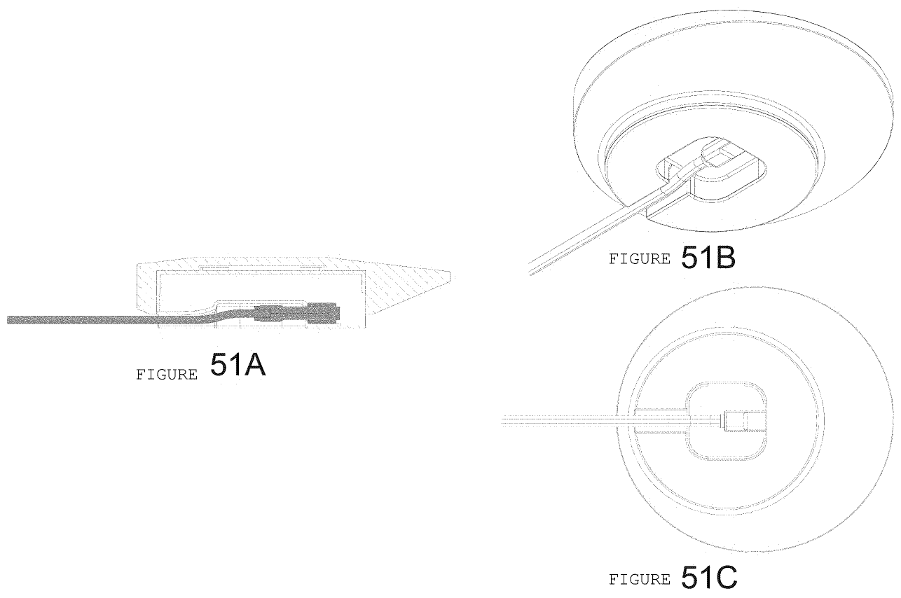

FIGS. 51A-C show a sectional side view, bottom perspective view and bottom view of a cable with a micro-connector that is inserted into a device, such as a wireless charger. The power charger includes a micro-inlet that is located at the centre of the charger and a passageway to provide a path of the micro-connector cable.

Application of the micro-inlets or micro-connectors also include for example the integration with flat-screen OLED televisions.

### Appendix: Key Features

The key features are now generalised. We also list various optional sub-features for each feature. Note that any feature can be combined with one or more other features, including all the features or sub-features. No single feature is mandatory.

The key features are organised in the following sections:
Section I. Micro-inlet
Section II. Micro-coupler
Section III. Micro-connector
Section IV. Electronic device integrated the micro-inlet

Section I. Micro Inlet

Key Feature a—the Height of the Recessed Cavity is Less than Approximately 7 mm

A mains power inlet for an electrical connector, the power inlet comprising:
a) a housing including a recessed cavity; and
b) at least two electrical pins that are arranged inside the recessed cavity; and in which the height of the recessed cavity is less than approximately 7 mm.

Key Feature B— the Height of the Housing is Less than Approximately 10 mm

A mains power inlet for an electrical connector, the power inlet comprising:
a) a housing including a recessed cavity; and
b) at least two electrical pins that are arranged inside the recessed cavity; and in which the height of the housing is less than approximately 10 mm.

Key Feature C—the Volume of the Recessed Cavity is Less than Approximately 800 Mm³

A mains power inlet for an electrical connector, the power inlet comprising:
a) a housing including a recessed cavity; and
b) at least two electrical pins that are arranged inside the recessed cavity; and in which the volume of the cavity is less than approximately 800 mm³.

Key Feature D—the Front Surface of the Housing has a Rectangular Opening and the Clearance Distance Between the Live Pin and the Neutral Pin is Less than Approximately 4 mm

A mains power inlet for an electrical connector, the power inlet comprising:
a) a housing including a front surface with an opening that is generally rectangular and a recessed cavity extending from the opening;
b) at least two electrical pins that are arranged inside the recessed cavity, and in which the clearance distance between the pins is less than approximately 4 mm

Key Feature E—the Power Inlet Comprises Three Coplanar Electrical Pins which are Aligned Horizontally Along a Width of the Recessed Cavity

A mains power inlet for an electrical connector, the power inlet comprising:
a) a housing including a recessed cavity; and
b) three electrical pins that are arranged inside the recessed cavity; and in which the three pins are coplanar and aligned horizontally along a width of the recessed cavity.

Key Feature F—the Power Inlet Comprises Three Conductive Pins which are Aligned Horizontally Along the Width of the Housing and the Width of the Recessed Cavity is Less than Approximately 19 mm

A mains power inlet for an electrical connector, the power inlet comprising:
a) a housing including a recessed cavity; and
b) three electrical pins that are arranged inside the recessed cavity;
in which the three pins are coplanar and aligned horizontally along a width of the recessed cavity; and in which the width of the recessed cavity is less than approximately 19 mm.

General Regulations
The inlet is configured to meet the IEC 60320 regulations for electrical, safety and thermal requirements.
The inlet is configured to meet the IEC 60320 safety regulations, such as clearance and creepage distances.
The inlet and connector achieve a maximum working power of 750 W.
The inlet and connector have a maximum rated current of 3 A

Contact Points
Contact points are attached or located near an external surface of the housing, the contact points configured to provide an electrical connection to an electrical device or an electrical cord.
The inlet includes a soldering element located at an exterior surface of the housing.

General Dimensions
The depth of the recessed cavity is less than approximately 10 mm.
The mass of the housing is less than approximately 1.5 g when the power inlet comprises two pins.
The mass of the housing is less than approximately 2.1 g when the power inlet comprises three pins.
The housing has a volume that is less than approximately 1100 mm³.
The front surface of the housing has generally a rectangular opening, with the recessed cavity extending from the front surface.
The recessed cavity has a box shape.
The housing has a box shape.

Pin Configuration
The dimension and shape of each pin are configured to provide mechanical robustness.
The shape of each pin is configured to provide enough metal area for contacting the electrical contacts of a matching connector while providing minimum electrical resistance
The cross-sectional area of a pin is less than approximately 3.5 mm².
The clearance distance between an earth pin and a live or neutral pin is less than approximately 5 mm.

Vertical Pin Design
The width of the recessed cavity is less than approximately 12 mm, when the power inlet comprises two pins.
The width of the housing is less than approximately 14.5 mm, when the power inlet comprises two pins.
The width of the recessed cavity is less than approximately 19 mm, when the power inlet comprises three pins.
The width of the housing is less than approximately 22 mm, when the power inlet comprises three pins.

Horizontal Pin Design
The width of the recessed cavity is less than approximately 15 mm, when the power inlet comprises two pins.
The width of the housing is less than approximately 18 mm, when the power inlet comprises two pins.
The width of the recessed cavity is less than approximately 23 mm when the power inlet comprises three pins.
The width of the housing is less than approximately 26 mm when the power inlet comprises three pins.

Reinforced Vertical Pin Design
The housing includes at least two support sections located inside the recessed cavity, in which each support section is configured to securely hold a pin in place.
The support sections are adjacent to a bottom wall of the recessed cavity.
Each support section is located orthogonally to a pin.
The length of each support section is less than about half of the length of the pin it is supporting.
The support sections and the housing form a single moulded unit made of the same insulating material, such as PA6

Section II. Micro-Coupler

Key Feature a—the Height of the Inlet Recessed Cavity is Less than Approximately 7 mm

An interconnection coupler comprising:
(i) a mains power inlet; and
(ii) a connector for connecting into the mains power inlet;
and in which the mains power inlet comprises:
a housing including a recessed cavity; and
at least two electrical pins that are arranged inside the recessed cavity: and in which the height of the recessed cavity is less than approximately 7 mm.

Key Feature B— the Height of the Inlet Housing is Less than Approximately 10 mm

An interconnection coupler comprising:
(i) a mains power inlet; and
(ii) a connector for connecting into the mains power inlet;
and in which the mains power inlet comprises:
a housing including a recessed cavity; and
at least two electrical pins that are arranged inside the recessed cavity; and in which the height of the housing is less than approximately 10 mm.

Key Feature C—the Volume of the Inlet Recessed Cavity is Less than Approximately 800 mm³

An interconnection coupler comprising:
(i) a mains power inlet; and
(ii) a connector for connecting into the mains power inlet;
and in which the mains power inlet comprises:
a housing including a recessed cavity; and
at least two electrical pins that are arranged inside the recessed cavity; and in which the volume of the recessed cavity is less than approximately 800 m³.

Key Feature D—the Front Surface of the Housing of the Micro-Inlet has a Rectangular Opening and the Clearance Distance Between the Live Pin and the Neutral Pin is Less than Approximately 4 mm

An interconnection coupler comprising:
(i) a mains power inlet; and
(ii) a connector for connecting into the mains power inlet.
in which the mains power inlet comprises:
a housing including a front surface with an opening that is generally rectangular and a recessed cavity extending from the opening: and
at least two electrical pins that are arranged inside the recessed cavity; and in which the clearance distance between the pins is less than approximately 4 mm.

Key Feature E—the Micro-Coupler Comprises Three Coplanar Conductive Pins which are Aligned Horizontally Along a Width of the Recessed Cavity of the Micro-Inlet.

An interconnection coupler comprising:
(i) a mains power inlet; and
(ii) a connector for connecting into the mains power inlet;
in which the mains power inlet comprises:
a housing including a recessed cavity; and
three electrical pins that are arranged inside the recessed cavity;
and in which the three pins are coplanar and aligned horizontally along a width of the recessed cavity.

Key Feature F—the Power Inlet Comprises Three Conductive Pins which are Aligned Horizontally Along the Width of the Housing and the Width of the Recessed Cavity is Less than Approximately 19 mm

An interconnection coupler comprising:
(i) a mains power inlet; and
(ii) a connector for connecting into the mains power inlet.
in which the mains power inlet comprises:
a housing including a recessed cavity; and
three electrical pins that are arranged inside the recessed cavity;
and in which the three pins are coplanar and aligned horizontally along a width of the recessed cavity; and in which the width of the recessed cavity is less than approximately 19 mm.

General Regulations
The connector is configured to meet the IEC 60320 regulations for electrical, safety and thermal requirements.
The connector is configured to meet the IEC 60320 safety regulations, such as clearance and creepage distances
The inlet and connector achieve a maximum working power of 750 W
The inlet and connector have a maximum rated current of 3 A.

Section III. Micro-Connector

Key Feature a—the Height of the Connector Housing is Less than Approximately 7 Mm

A connector for connecting into a mains power inlet, the mains power inlet comprising at least two pins, in which the connector comprises:
a housing including at least two recessed openings or holes for receiving each pin of the mains power inlet, in which the recessed holes include electrical contacts, and
in which the height of the housing is less than approximately 7 mm.

Key Feature B—the Volume of the Connector Housing is Less than Approximately 800 m³

A connector for connecting into a mains power inlet, the mains power inlet comprising at least two pins, in which the connector comprises:
a housing including at least two recessed openings or holes for receiving each pin of the mains power inlet, in which the recessed holes include electrical contacts, and
in which the volume of the housing is less than 800 m³

Key Feature C—the Front Surface of the Connector Housing is Rectangular and the Distance Between the Two Recessed Holes is Approximately Less than 4 mm.

A connector for connecting into a mains power inlet, the mains power inlet comprising at least two pins, in which the connector comprises:
a housing including at least two recessed openings or holes for receiving each pin of the mains power inlet, in which the recessed holes include electrical contacts, and in which the clearance distance between the recessed holes is approximately less than 4 mm.

Key Feature D—the Connector Comprises Three Coplanar Holes which are Aligned Horizontally Along a Width of the Housing.

A connector for connecting into a mains power inlet, the mains power inlet comprising three pins, in which the connector comprises:
a housing including three openings or holes for receiving each pin of the mains power inlet, in which the recessed holes include electrical contacts, and in which the three holes are coplanar and aligned horizontally along a width of the housing.

Key Feature E—the Connector Comprises Three Coplanar Holes which are Aligned Horizontally Along a Width of the Housing and the Width of the Housing is Less than Approximately 18 mm

A connector for connecting into a mains power inlet, the mains power inlet comprising three pins, in which the connector comprises:
a housing including three openings or holes for receiving each pin of the mains power inlet, in which the recessed holes include electrical contacts, and in which the three holes are coplanar and aligned horizontally along a width of the housing and in which the width of the housing is less than approximately 18 mm.

General Regulations
The connector is configured to meet the IEC 60320 regulations for electrical, safety and thermal requirements.
The connector is configured to meet the IEC 60320 safety regulations, such as clearance and creepage distances.
The inlet and connector achieve a maximum working power of 750 W.
The inlet and connector have a maximum rated current of 3 A

General Dimensions
The front surface of the housing has generally a rectangular shape.
The housing has a box shape.
The width of the housing is less than approximately 12 mm, when the connector comprises two recessed holes or openings.
The width of the housing is less than approximately 18 mm, when the connector comprises three recessed holes or openings.
The depth of the housing is less than approximately 10 mm.

Electrical Contact Configuration
Each electrical contact is made of a single piece of conductive material that is configured to widen during insertion of the connector into the power inlet.
A rigid insulating element is located between two branches of the electrical contacts.

Cord Set
The connector is configured to connect to a first end of a cord set
The cord set comprises a country-specific wall connector at a second end of the cord set.

Section IV. Electronic Device Integrated the Micro-Inlet

Key Feature A—the Height of the Inlet Cavity is Less than Approximately 10 mm

An electronic device integrated with a mains power inlet for an electrical connector, the mains power inlet comprising:
a) a recessed cavity; and
b) at least two electrical pins that are arranged inside the recessed cavity; and in which the height of the recessed cavity is less than approximately 7 mm.

Key Feature B— the Volume of the Inlet Recessed Cavity is Less than Approximately 800 m³

An electronic device integrated with a mains power inlet for an electrical connector, the mains power inlet comprising:
a) a recessed cavity; and
b) at least two electrical pins that are arranged inside the recessed cavity; and in which the volume of the recessed cavity is less than 800 m³.

Key Feature C—the Front Surface of the Inlet Recessed Cavity has a Rectangular Opening and the Clearance Distance Between the Live Pin and the Neutral Pin is Less than Approximately 4 mm

An electronic device integrated with a mains power inlet for an electrical connector, the mains power inlet comprising:
a) a recessed cavity; in which the recessed cavity has a front opening that is generally rectangular; and
b) at least two electrical pins that are arranged inside the recessed cavity; and in which the clearance distance between the pins is less than approximately 4 mm.

Key Feature D—the Power Inlet Comprises Three Coplanar Conductive Pins which are Aligned Horizontally Along a Width of the Recessed Cavity

An electronic device integrated with a mains power inlet for an electrical connector, the mains power inlet comprising:
a) a recessed cavity; and
b) at least two electrical pins that are arranged inside the recessed cavity;
and in which the three pins are coplanar and aligned horizontally along a width of the recessed cavity.

Key Feature E—the Power Inlet Comprises Three Conductive Pins which are Aligned Horizontally Along the Width of the Housing and the Width of the Recessed Cavity is Less than Approximately 19 mm

An electronic device integrated with a mains power inlet for an electrical connector, the mains power inlet comprising:
a) a recessed cavity; and
b) three electrical pins that are arranged inside the recessed cavity;
and in which the three pins are coplanar and aligned horizontally along a width of the recessed cavity; and in which the width of the recessed cavity is less than approximately 19 mm.

Device Including the Inlet
The power inlet is located at the center of or inside the electronic device.
The power inlet is not visible externally from the electronic device.
The electronic device includes a passageway that is configured to provide a path for a cable including a matching connector to be inserted into the power inlet.
The passageway has a height that is less than approximately 10 mm.
The passageway has a width that is less than approximately 35 mm.
The passageway has a depth that is less than approximately 35 mm.
The power inlet is mounted on an electrical device via THT (through hole technology) or SMD (surface mount device) configurations.
The electronic device is a power supply and the height of the power supply is approximately less than 15 mm.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-68. (canceled)

69. A mains power inlet for an electrical connector, the power inlet comprising:
a) a housing including a recessed cavity; and
b) at least two electrical pins that are arranged inside the recessed cavity; and
in which the height of the recessed cavity is less than approximately 7 mm.

70. The mains power inlet of claim 69, in which at least one of the following conditions applies:
the height of the housing is less than approximately 10 mm;
the housing has a box shape;
the mass of the housing is less than approximately 1.5 g when the power inlet comprises two pins;
the housing has a volume that is less than approximately 1100 mm³;
the width of the housing is less than approximately 23 mm, preferably less than 14 mm;
the volume of the recessed cavity is less than approximately 800 mm³.
the depth of the recessed cavity is less than approximately 10 mm;
the recessed cavity has a box shape;
the width of the recessed cavity is less than approximately 15 mm, preferably less than approximately 12 mm;
the recess cavity extends from a rectangular opening of a front surface of the housing;
the clearance distance between the electrical pins is less than approximately 4 mm;
cross-sectional area of a pin is less than approximately 3.5 mm²;
the pins are oriented horizontally in relation to the width of the recessed cavity.

71. The mains power inlet of claim 69, in which at least one of the following conditions apply:
the power inlet and connector achieve a maximum working power of 750 W;
the power inlet and connector have a maximum rated current of 3 A.

72. The mains power inlet of claim 69, in which the power inlet comprises contact points that are attached or located near an external surface of the housing, the contact points configured to provide an electrical connection to an electrical device or an electrical cord.

73. The mains power inlet of claim 69, in which the housing includes at least two support sections located inside the recessed cavity, in which each support section is configured to securely hold a pin in place.

74. The mains power inlet of claim 73, in which at least one of the following conditions applies:
the support sections are adjacent to a bottom wall of the recessed cavity;
each support section is located orthogonally to a pin;
the length of each support section is less than approximately half of the length of the pin it is supporting;
support sections and the housing form a single moulded unit made of the same insulating material, such as PA6.

75. The mains power inlet of claim 69, in which the power inlet comprises three electrical pins and in which the three pins are coplanar and aligned horizontally along a width of the recessed cavity.

76. The mains power inlet of claim 75, in which at least one of the following conditions applies:
the distance between an earth pin and a live or neutral pin is less than approximately 5 mm;
the pins are oriented horizontally in relation to the width of the recessed cavity;
the mass of the housing is less than approximately 2.1 g;
the width of the housing is less than approximately 26 mm, preferably less than 22 mm;
the width of the recessed cavity is less than approximately 23 mm, preferably less than approximately 19 mm.

77. A connector for connecting into a mains power inlet, the mains power inlet comprising at least two pins, in which the connector comprises: a housing including at
least two recessed openings or holes for receiving each pin of the mains power inlet, in
which the recessed holes include electrical contacts, and in which the height of the housing is less than approximately 7 mm.

78. The connector of claim 77, in which at least one of the following conditions applies:
the volume of the housing is less than 800 m³;
the width of the housing is less than approximately 19 mm;
the housing has a box shape;
the width of the housing is less than approximately 12 mm, when the connector comprises two recessed openings or holes;
the width of the housing is less than approximately 18 mm, when the connector comprises three recessed openings or holes;
the depth of the housing is less than approximately 10 mm;
the clearance distance between the recessed opening or holes is approximately less than 4 mm;
the recessed opening or holes are located on a front surface of the housing having generally a rectangular shape;
each electrical contact is made of a single piece of conductive material that is configured to widen during insertion of the connector into the power inlet.

79. The connector of claim 77, in which the housing includes three recessed openings or holes and in which the three recessed openings or holes are coplanar and aligned horizontally along the width of the housing.

80. The connector of claim 77, in which a rigid insulating element is located between two branches of the electrical contacts.

81. An electronic device integrated with a mains power inlet for an electrical connector according to claim 69.

82. The electronic device of claim 81, in which the power inlet is located at the center of or inside the electronic device, and in which the electronic device includes a passageway that is configured to provide a path for a cable including a matching connector to be inserted into the power inlet.

83. The electronic device of claim 82, in which at least one of the following conditions applies:
the passageway has a height that is less than approximately 10 mm;
the passageway has a width that is less than approximately 35 mm;
the passageway has a depth that is less than approximately 35 mm;
the electronic device is a power supply and the height of the power supply is less than approximately 15 mm.
